(19) United States
(12) Patent Application Publication
(10) Pub. No.: US 2026/0301726 A1
(43) Pub. Date: Oct. 1, 2026

(54) SYSTEMS AND METHODS FOR SIGNAL CONTROL ACROSS AUDIO, OPTICAL, AND SENSING PLATFORMS

(71) Applicant: Meta Platforms Technologies, LLC, Menlo Park, CA (US)

(72) Inventors: Gengxi Lu, Pasadena, CA (US); Francesco Marsili, South Pasadena, CA (US); Danielle Gelb, New York, NY (US); Ryan Alexander Chavez, Seattle, WA (US)

(21) Appl. No.: 19/574,011

(22) Filed: Mar. 20, 2026

Related U.S. Application Data
(60) Provisional application No. 63/781,668, filed on Apr. 1, 2025.
(60) Provisional application No. 63/895,569, filed on Oct. 8, 2025.

(51) Int. Cl. G10K 11/00; H04R 5/04

(52) U.S. Cl. CPC G10K 11/002; H04R 5/04; G10K 2200/10; H04R 2430/01

(57) ABSTRACT

A method comprising using an array of sensors to record a pitch-catch waveform, re-emitting and combining a recorded pulse-echo measurement of the time reversed pitch-catch waveform and the time reversed pitch-catch waveform, and generating a final output of the pitch-catch waveform, and a method for detecting, by a system, a plurality of users concurrently listening to an audio stream, muting, by the system, at least a portion of the audio stream, and transmitting the audio stream comprising the muted portion of the audio stream. Various systems and methods are disclosed.

### CROSS REFERENCE TO RELATED APPLICATION

This application claims priority to multiple U.S. Provisional Applications, namely, U.S. Provisional Application No. 63/781,668, filed 1 Apr. 2025, and U.S. Provisional Application No. 63/895,569, filed 8 Oct. 2025.

### BRIEF DESCRIPTION OF THE DRAWINGS

The accompanying drawings illustrate a number of exemplary aspects and are a part of the specification. Together with the following description, these drawings demonstrate and explain various principles of the present disclosure.

FIG. 1 illustrates a signal transmitted through a medium in a time reversal system, according to some aspects.

FIG. 2 illustrates a time reversed signal transmitted back through a medium in a time reversal system, according to certain aspects.

FIG. 3 illustrates a pulse echo received after retransmitting the signal back through a medium, according to particular aspects.

FIG. 4 illustrates a first step of a double pass time reversal system, according to some aspects.

FIG. 5 illustrates a second step of a double pass time reversal system, according to certain aspects.

FIG. 6 illustrates a complete double pass time reversal signal for full dispersion compensation, according to particular aspects.

FIG. 7 illustrates an improved signal to noise ratio using a double pass time reversal system, according to some aspects.

FIG. 8 is a schematic diagram illustrating an example use case for an automatic muting for multiple members in the same microphone-enabled platform, in accordance with some aspects of the subject technology.

FIG. 9 is an illustration of an example artificial-reality system according to some aspects of this disclosure.

FIG. 10 is an illustration of an example artificial-reality system with a handheld device according to some aspects of this disclosure.

FIG. 11A is an illustration of example user interactions within an artificial-reality system according to some aspects of this disclosure.

FIG. 11B is an illustration of example user interactions within an artificial-reality system according to some aspects of this disclosure.

FIG. 12A is an illustration of example user interactions within an artificial-reality system according to some aspects of this disclosure.

FIG. 12B is an illustration of example user interactions within an artificial-reality system according to some aspects of this disclosure.

FIG. 13 is an illustration of an example wrist-wearable device of an artificial-reality system according to some aspects of this disclosure.

FIG. 14 is an illustration of an example wearable artificial-reality system according to some aspects of this disclosure.

FIG. 15 is an illustration of an example augmented-reality system according to some aspects of this disclosure.

FIG. 16A is an illustration of an example virtual-reality system according to some aspects of this disclosure.

FIG. 16B is an illustration of another perspective of the virtual-reality systems shown in FIG. 18A.

FIG. 17 is a block diagram showing system components of example artificial-and virtual-reality systems.

FIG. 18A is an illustration of an example intermediary processing device according to aspects of this disclosure.

FIG. 18B is a perspective view of the intermediary processing device shown in FIG. 18A.

FIG. 19 is a block diagram showing example components of the intermediary processing device illustrated in FIGS. 18A and 18B.

FIG. 20A is front view of an example haptic feedback device according to aspects of this disclosure.

FIG. 20B is a back view of the example haptic feedback device shown in FIG. FIG. 22A according to aspects of this disclosure.

FIG. 21 is a block diagram of example components of a haptic feedback device according to aspects of this disclosure.

FIG. 22 is an illustration of an example system that incorporates an eye-tracking subsystem capable of tracking a user's eye(s).

FIG. 23 is a more detailed illustration of various aspects of the eye-tracking subsystem illustrated in FIG. 22.

FIG. 24 is an illustration of an example fluidic control system that may be used in connection with aspects of this disclosure.

### DETAILED DESCRIPTION OF EXEMPLARY ASPECTS

Existing time reversal techniques manipulate waves such as sound, light, or seismic waves, such that these waves retrace their paths back to their sources. For example, in medical imaging, time reversal technology may focus ultrasound waves more precisely to improve the clarity of images. In wireless communication, time reversal technology may enhance signal quality by reducing interference, while in seismology, time reversal technology may aid in accurately locating earthquake epicenters by analyzing how seismic waves travel.

This process may begin by capturing wavefronts using an array of sensors or transducers that record both amplitude and phase information. The recorded signals may then be processed, often digitally using signal processing algorithms, to produce a time reversed version of the original wavefront. These signals may then be re-emitted back into the medium from the same array of sensors or transducers, causing the waves to propagate backward along their initial paths. As they travel, the waves naturally refocus and converge at their original source location.

In this manner, wave focusing may occur as the time reversed waves converge at the original source location, effectively undoing the dispersion and scattering that occurred during the initial propagation. This effect may enable time reversal technology across various fields to improve wave control precision and efficiency in complex environments. In some examples, an iterative time reversal technique may be employed, in which the time reversal algorithm may be repeated multiple times to further enhance wave focusing at a desired location. However, existing time reversal techniques rely on detection of reflected signals, which suffer from a low signal-to-noise ratio and degraded signal quality, which limit the accuracy and effectiveness of the focusing process.

The present disclosure is generally directed to a method for double time reversal by utilizing high quality pitch-catch waveforms. For example, time reversal may be conducted twice, once in hardware and once digitally. The disclosed method may address the improvement of a signal-to-noise ratio by enabling a higher quality of time reversal. Furthermore, compared to conventional time reversal technology that captured unwanted noise of the time reversal wave, the disclosed method may digitally filter the noise associated with the re-emitted time reversal wave.

Further, the present disclosure is also directed to automatic muting of a speaker of a member in a platform when microphones of multiple members are being used by the same source. For example, the techniques to automatically mute a particular speaker of a member may enable speakers of, e.g., virtual reality (VR) headsets to detect when the same two or more users have their microphones utilized by, e.g., the same source. Currently, speakers that are using their respective microphones while using two different applications have to manually mute themselves in one application in order to prevent their voice from being heard twice (e.g., as an echo) by other listeners that are utilizing the application.

The automatic muting techniques described herein enable VR headsets to detect when a set of two users have their microphones being used by two sources, such as when two users are on the same call and playing the same game that is using their microphones. After detection, the system can automatically mute one of the speaker's voice streams, thereby preventing the listener from hearing the speaker's voice twice (echo). The speaker's voice stream is unaffected to the other users that are only in one of the environments.

The disclosed technology can improve the audio experience for users by reducing the amount of manual intervention needed for microphone outputs. For example, two users would be able to join two applications that use their microphones. If they are unmuted in both applications, they would hear each other's voice twice. A platform of the disclosed technology would mute one of the microphone outputs to prevent the echo.

The subject technology can be adopted into various platforms and services to improve the audio experience for when multiple users are in the same multiple environments using their microphone.

Features from any of the aspects described herein may be used in combination with one another in accordance with the general principles described herein. These and other aspects, features, and advantages will be more fully understood upon reading the following detailed description in conjunction with the accompanying drawings and claims.

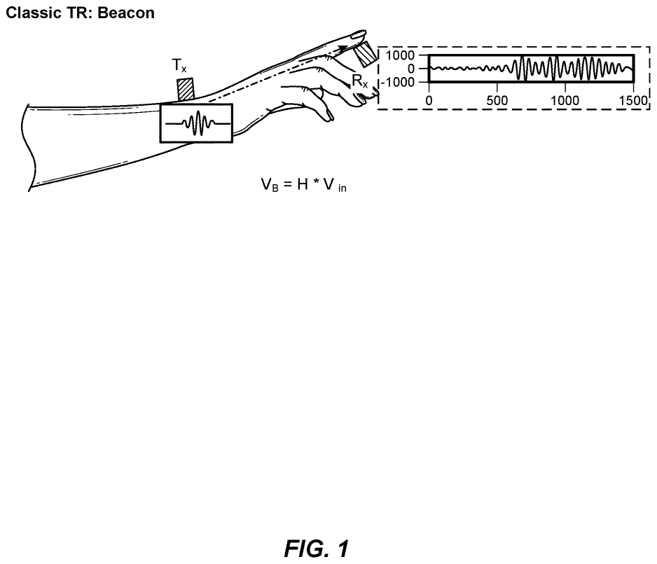

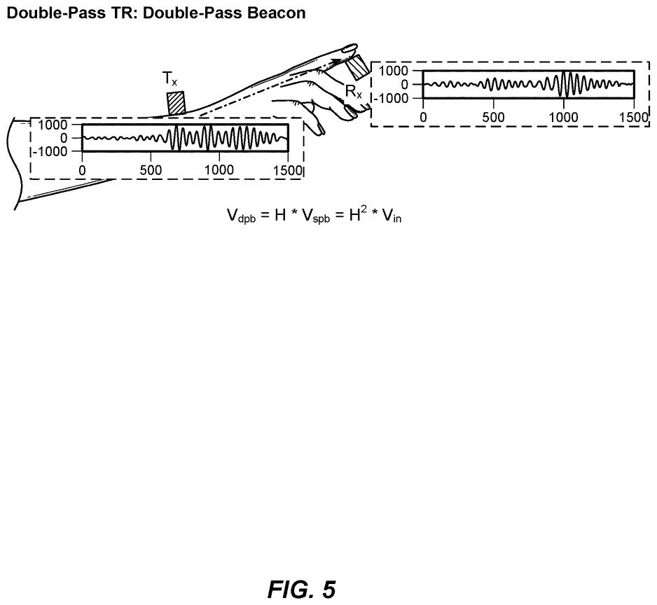

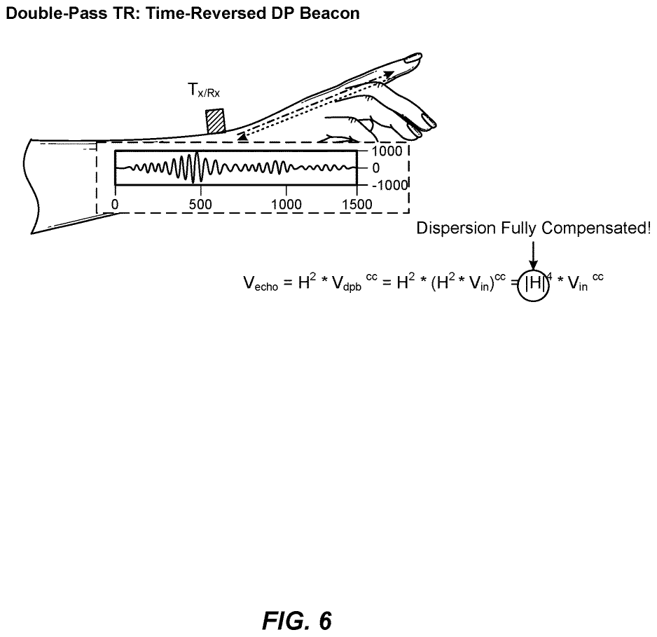

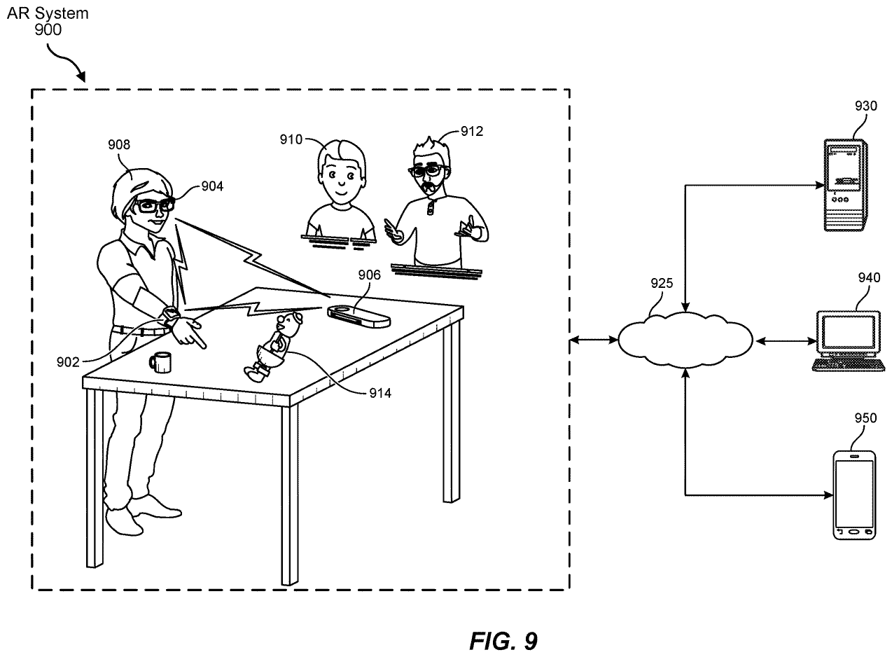

The following will provide, with reference to FIGS. 1-8, detailed descriptions of systems and method for signal control across audio, optical, and sensing platforms. The discussion associated with FIGS. 9-24 relates to exemplary augmented reality and virtual reality devices that may include signal control across audio, optical, and sensing platforms as disclosed herein.

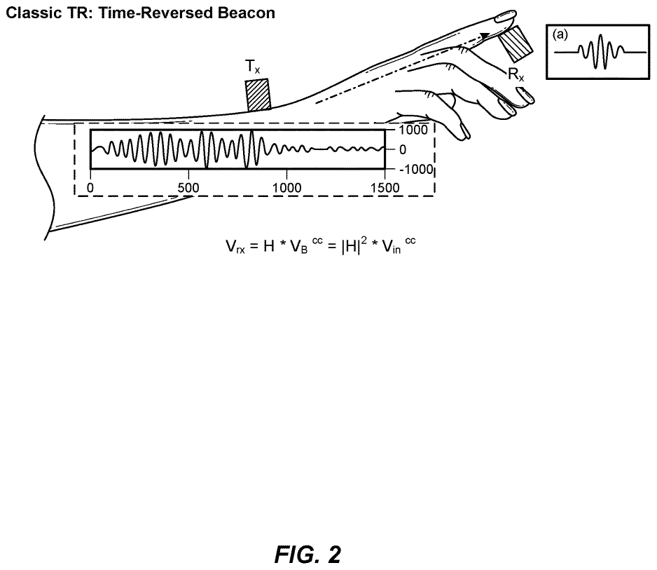

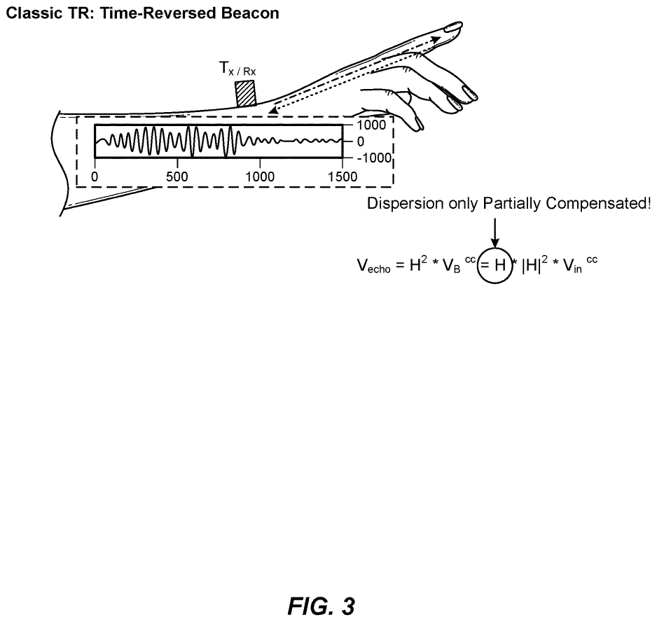

FIG. 1 illustrates a signal transmitted through a medium in a time reversal system, while FIG. 2 illustrates a time reversed signal transmitted back through a medium in a time reversal system. Furthermore, FIG. 3 illustrates a pulse echo received after retransmitting the signal back through a medium. For example, the time reversed pitch-catch waveform may be remitted to record a pulse-echo measurement of the time reversed pitch-catch waveform. As used herein, “a pulse-echo measurement” may generally refer to a method of determining properties of a material or detect defects by analyzing waves that are reflected back to the sensors. In this manner, upon re-emitting the pitch-catch waveform, the pulse-echo measurement may record any defects or scattering of the time reversed pitch-catch waveform. Upon recording the pulse-echo measurement of the pitch-catch waveform, the recorded pulse-echo measurement of the time reversed pitch-catch waveform and the time reversed pitch-catch waveform are combined to generate a final output signal of the pitch-catch waveform.

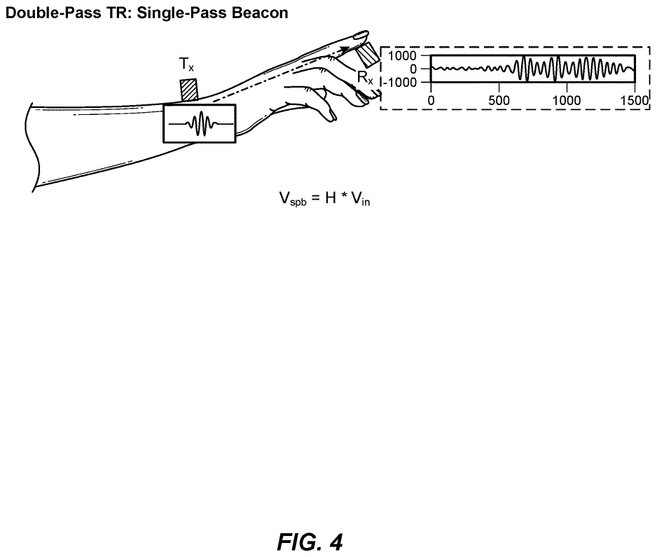

Turning to FIGS. 4, 5, and 6 a complete double pass time reversal system is illustrated. For example, the method of double time reversal may include using an array of sensors to record a pitch-catch waveform and processing the recorded pitch-catch waveform to create a time reversed pitch-catch waveform. The term “pitch-catch waveform” as used herein may generally refer to a signal recorded at a receiver after wave propagation from a separate transmitter. In some examples, processing the recorded pitch-catch waveform may include using signal processing algorithms and/or digital signal processing algorithms to reverse the recorded pitch-catch waveform. In further examples, the time reversed pitch-catch waveform may be emitted from the same array of sensors that initially recorded the pitch-catch waveform.

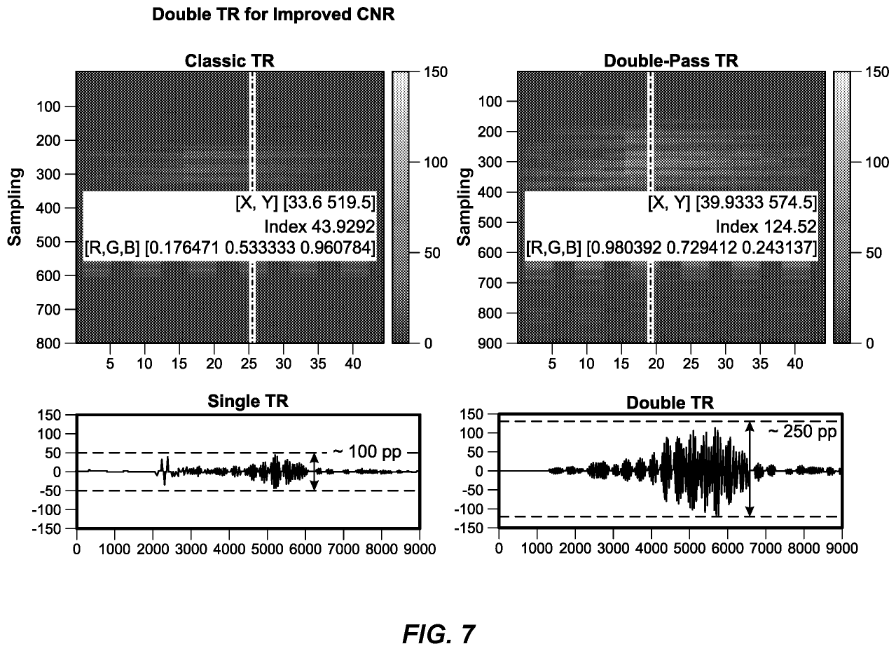

FIG. 7 illustrates an improved contrast to noise ratio using a double pass time reversal system. In further examples, the final output signal may have a higher signal-to-noise ratio due to the combination of the pulse-echo measurement with the time reversed pitch-catch waveform. For example, in addition to the re-focusing of the output signal, the application of the pulse-echo measurement on the time reversed pitch-catch waveform may filter out unwanted noise captured from the initial pitch-catch waveform. In this manner, while dispersion due to different frequency components traveling at different speeds of the captured pitch-catch waveform may have been only partially compensated for in traditional time reversal methods, the method of double time reversal may fully compensate for the dispersion in the pitch-catch waveform. Furthermore, an application of double time reversal for sensors and sensing components may significantly improve sensing capabilities and signal quality for various types of sensors including ultrasounds, acoustics, radar signals, etc.

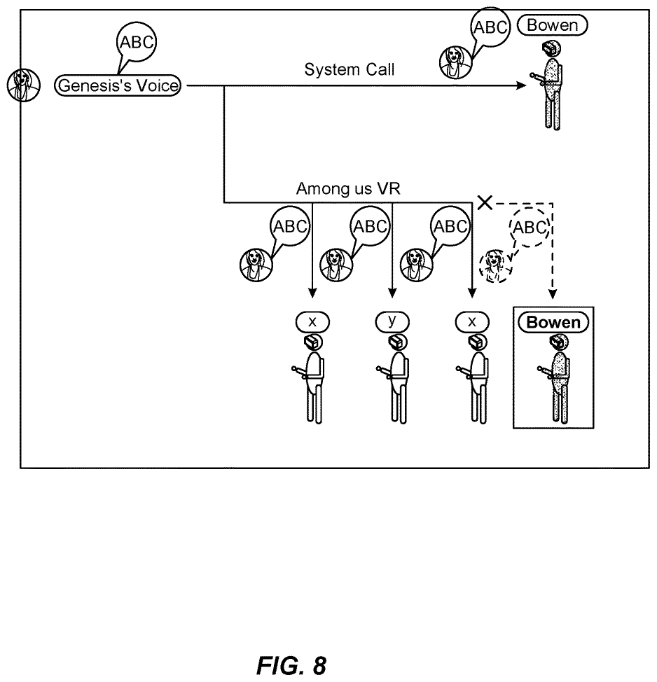

Turning now to FIG. 8, schematic diagram illustrates an example use case for an automatic muting for multiple members in the same microphone enabled platform, in accordance with some aspects of the subject technology. The scenario depicted in FIG. 8 shows an example of an application of the disclosed technology, when users x, y, z and Mr. Brown are using their VR headset and are mutually playing a game. However, when a system call arrives to Mr. Brown, his VR headset detects the call and automatically mutes one of the voice streams of Mr. Brown's headset speaker to prevent echo. The muting can be performed by a processor of the VR headset.

In conclusion, the disclosed subject technology is directed to automatic muting of a speaker of a member in a platform when microphones of multiple members are being used by the same source. In some aspects, VR headsets can detect when the same two or more users have their microphones being used by the same two sources. In one or more aspects, the VR headsets can mute a speaker of a user of the two or more users to prevent echo. In some aspects, the two or more users are using the same application. In one or more aspects, the same application is a game being played by the two or more users. In one or more aspects, muting a speaker of a user of the two or more users is executed by a processor of a corresponding VR headset of the VR headsets.

### EXAMPLE ASPECTS

Example 1: A method including using an array of sensors to record a pitch-catch waveform, processing the recorded pitch-catch waveform to create a time reversed pitch-catch waveform, emitting the time reversed pitch-catch waveform, re-emitting the time reversed pitch-catch waveform to record a pulse-echo measurement of the time reversed pitch-catch waveform, combining the recorded pulse-echo measurement of the time reversed pitch-catch waveform and the time reversed pitch-catch waveform, and generating a final output of the pitch-catch waveform.

Example 2: A method including detecting, by a system, a plurality of users concurrently listening to an audio stream in a plurality of audio sources, muting, by the system, at least a portion of the audio stream based on detecting the plurality of users listening to the audio stream, and transmitting the audio stream comprising the muted portion of the audio stream.

Aspects of the present disclosure may include or be implemented in conjunction with various types of Artificial Reality- (AR) systems. AR may be any superimposed functionality and/or sensory-detectable content presented by an artificial-reality system within a user's physical surroundings. In other words, AR is a form of reality that has been adjusted in some manner before presentation to a user. AR can include and/or represent virtual reality (VR), augmented reality, mixed AR (MAR), or some combination and/or variation of these types of realities. Similarly, AR environments may include VR environments (including non-immersive, semi-immersive, and fully immersive VR environments), augmented-reality environments (including marker-based augmented-reality environments, markerless augmented-reality environments, location-based augmented-reality environments, and projection-based augmented-reality environments), hybrid-reality environments, and/or any other type or form of mixed-or alternative-reality environments.

AR content may include completely computer-generated content or computer-generated content combined with captured (e.g., real-world) content. Such AR content may include video, audio, haptic feedback, or some combination thereof, any of which may be presented in a single channel or in multiple channels (such as stereo video that produces a three-dimensional (3D) effect to the viewer). Additionally, in some aspects, AR may also be associated with applications, products, accessories, services, or some combination thereof, that are used to, for example, create content in an artificial reality and/or are otherwise used in (e.g., to perform activities in) an artificial reality.

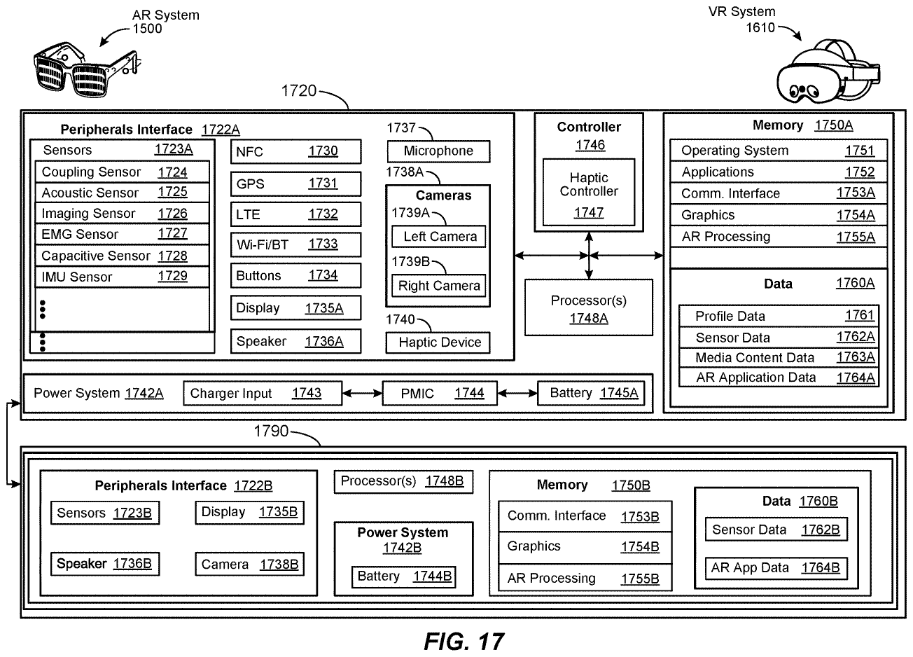

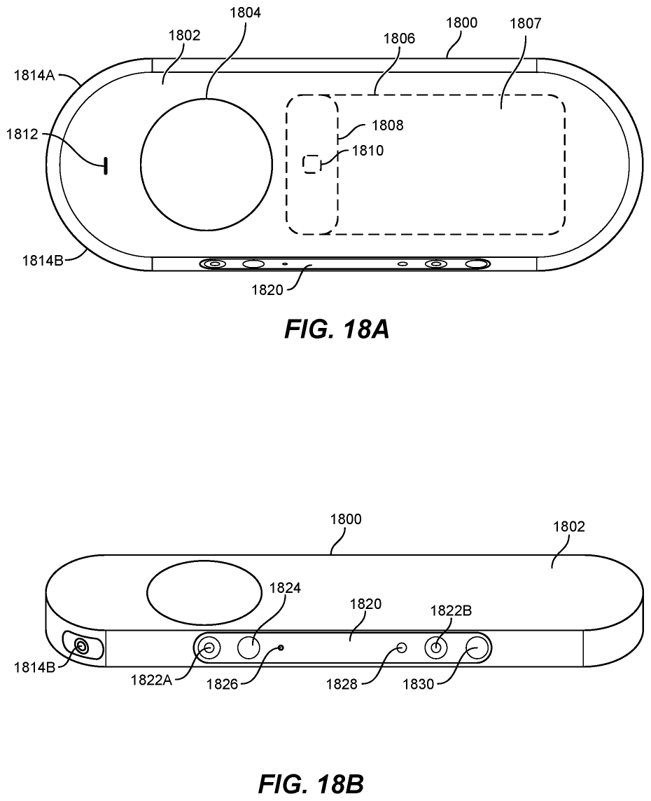

AR systems may be implemented in a variety of different form factors and configurations. Some AR systems may be designed to work without near-eye displays (NEDs). Other AR systems may include a NED that also provides visibility into the real world (such as, e.g., augmented-reality system 1700 in FIG. 17) or that visually immerses a user in an artificial reality (such as, e.g., virtual-reality system 1800 in FIGS. 18A and 18B). While some AR devices may be self-contained systems, other AR devices may communicate and/or coordinate with external devices to provide an AR experience to a user. Examples of such external devices include handheld controllers, mobile devices, desktop computers, devices worn by a user, devices worn by one or more other users, and/or any other suitable external system.

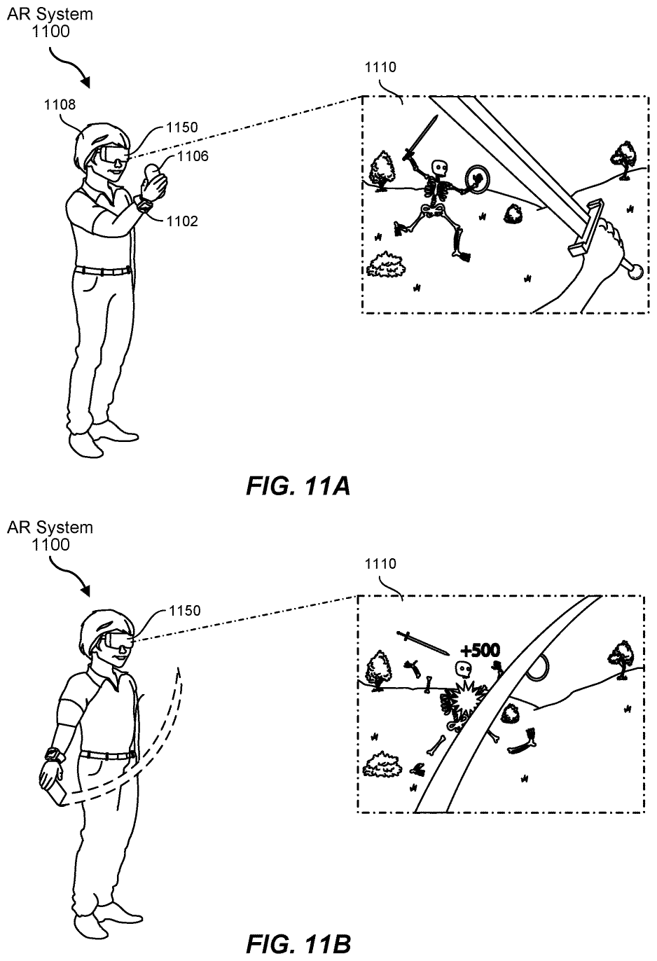

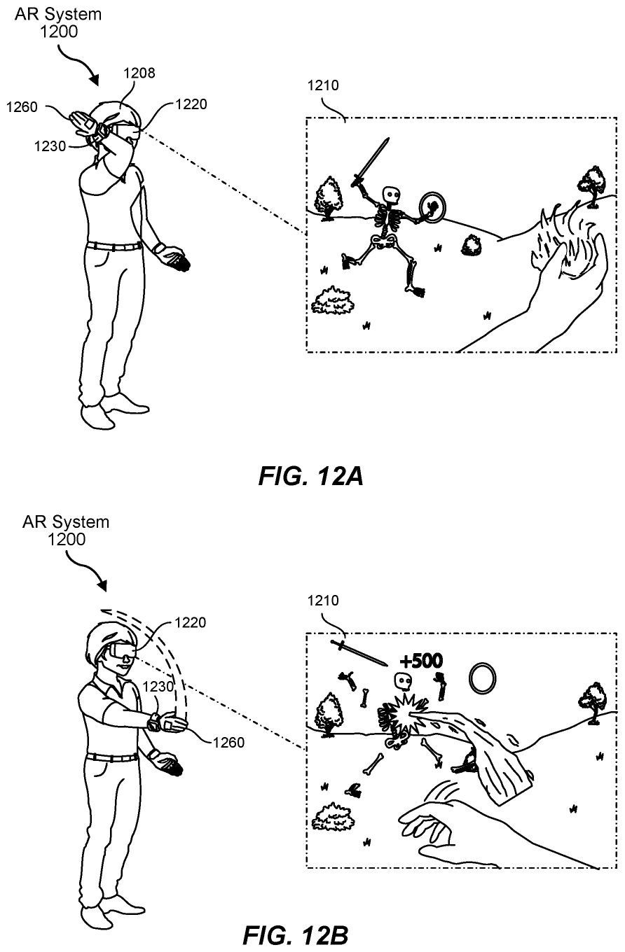

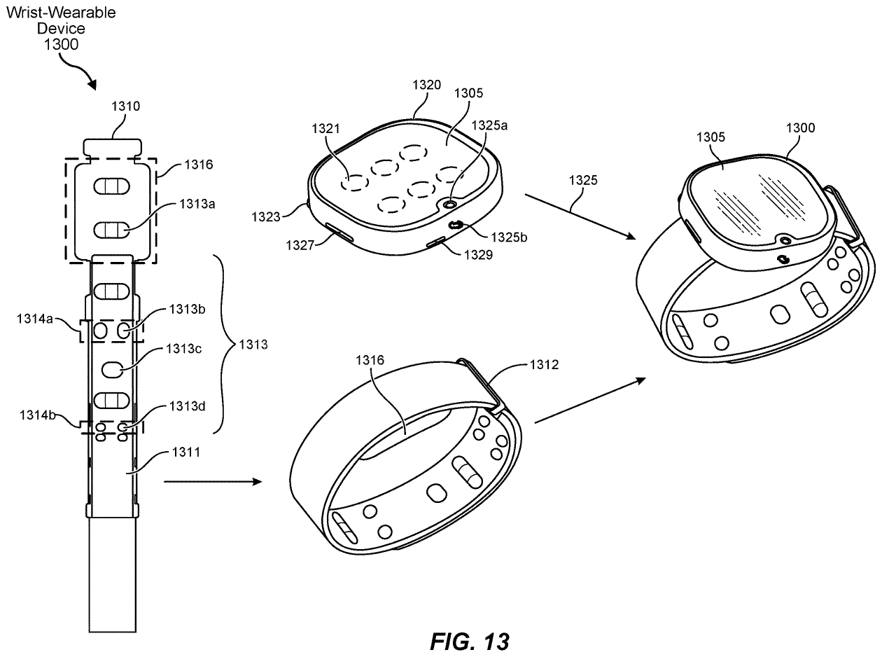

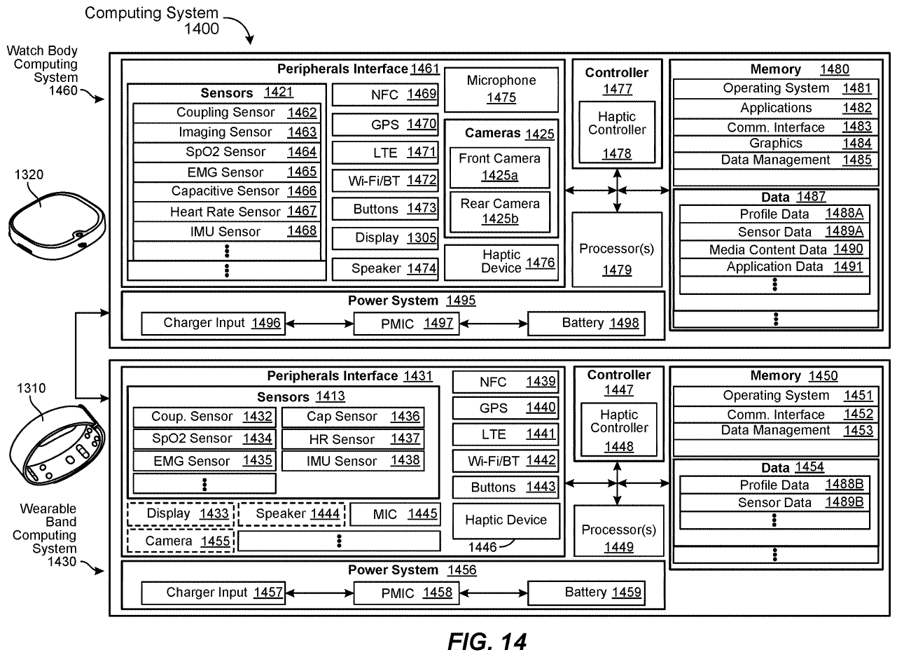

FIGS. 11-14B illustrate example artificial-reality (AR) systems in accordance with some aspects. FIG. 11 shows a first AR system 1100 and first example user interactions using a wrist-wearable device 1102, a head-wearable device (e.g., AR glasses 1700), and/or a handheld intermediary processing device (HIPD) 1106. FIG. 12 shows a second AR system 1200 and second example user interactions using a wrist-wearable device 1202, AR glasses 1204, and/or an HIPD 1206. FIGS. 13A and 13B show a third AR system 1300 and third example user 1308 interactions using a wrist-wearable device 1302, a head-wearable device (e.g., VR headset 1350), and/or an HIPD 1306. FIGS. 14A and 14B show a fourth AR system 1400 and fourth example user 1408 interactions using a wrist-wearable device 1430, VR headset 1420, and/or a haptic device 1460 (e.g., wearable gloves).

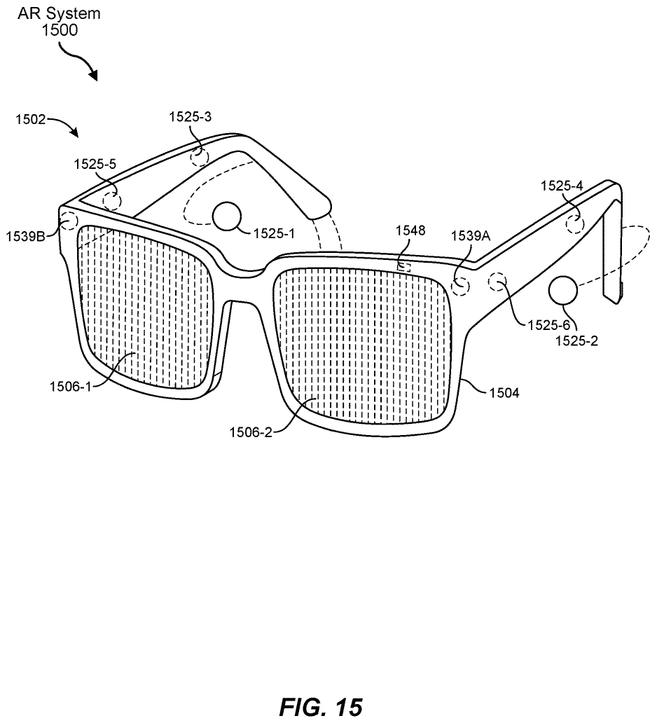

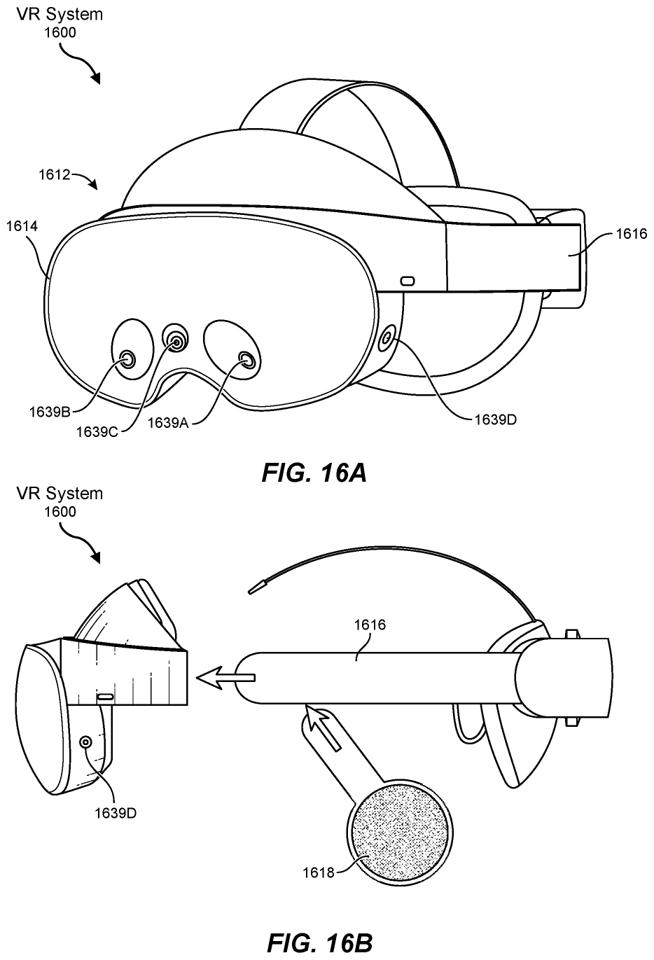

A wrist-wearable device 1500, which can be used for wrist-wearable device 1102, 1202, 1302, 1430, and one or more of its components, are described below in reference to FIGS. 15 and 16; head-wearable devices 1700 and 1800, which can respectively be used for AR glasses 1104, 1204 or VR headset 1350, 1420, and their one or more components are described below in reference to FIGS. 17-19.

Referring to FIG. 11, wrist-wearable device 1102, AR glasses 1104, and/or HIPD 1106 can communicatively couple via a network 1125 (e.g., cellular, near field, Wi-Fi, personal area network, wireless LAN, etc.). Additionally, wrist-wearable device 1102, AR glasses 1104, and/or HIPD 1106 can also communicatively couple with one or more servers 1130, computers 1140 (e.g., laptops, computers, etc.), mobile devices 1150 (e.g., smartphones, tablets, etc.), and/or other electronic devices via network 1125 (e.g., cellular, near field, Wi-Fi, personal area network, wireless LAN, etc.).

In FIG. 11, a user 1108 is shown wearing wrist-wearable device 1102 and AR glasses 1104 and having HIPD 1106 on their desk. The wrist-wearable device 1102, AR glasses 1104, and HIPD 1106 facilitate user interaction with an AR environment. In particular, as shown by first AR system 1100, wrist-wearable device 1102, AR glasses 1104, and/or HIPD 1106 cause presentation of one or more avatars 1110, digital representations of contacts 1112, and virtual objects 1114. As discussed below, user 1108 can interact with one or more avatars 1110, digital representations of contacts 1112, and virtual objects 1114 via wrist-wearable device 1102, AR glasses 1104, and/or HIPD 1106.

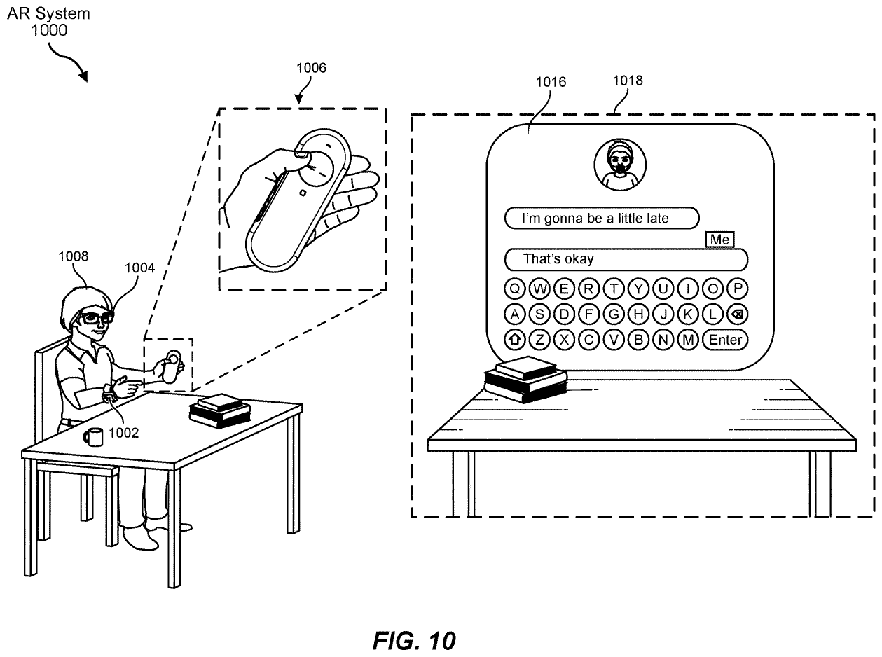

User 1108 can use any of wrist-wearable device 1102, AR glasses 1104, and/or HIPD 1106 to provide user inputs. For example, user 1108 can perform one or more hand gestures that are detected by wrist-wearable device 1102 (e.g., using one or more EMG sensors and/or IMUs, described below in reference to FIGS. 15 and 16) and/or AR glasses 1104 (e.g., using one or more image sensor or camera, described below in reference to FIGS. 17-10) to provide a user input. Alternatively, or additionally, user 1108 can provide a user input via one or more touch surfaces of wrist-wearable device 1102, AR glasses 1104, HIPD 1106, and/or voice commands captured by a microphone of wrist-wearable device 1102, AR glasses 1104, and/or HIPD 1106. In some aspects, wrist-wearable device 1102, AR glasses 1104, and/or HIPD 1106 include a digital assistant to help user 1108 in providing a user input (e.g., completing a sequence of operations, suggesting different operations or commands, providing reminders, confirming a command, etc.). In some aspects, user 1108 can provide a user input via one or more facial gestures and/or facial expressions. For example, cameras of wrist-wearable device 1102, AR glasses 1104, and/or HIPD 1106 can track eyes of user 1108 for navigating a user interface.

Wrist-wearable device 1102, AR glasses 1104, and/or HIPD 1106 can operate alone or in conjunction to allow user 1108 to interact with the AR environment. In some aspects, HIPD 1106 is configured to operate as a central hub or control center for the wrist-wearable device 1102, AR glasses 1104, and/or another communicatively coupled device. For example, user 1108 can provide an input to interact with the AR environment at any of wrist-wearable device 1102, AR glasses 1104, and/or HIPD 1106, and HIPD 1106 can identify one or more back-end and front-end tasks to cause the performance of the requested interaction and distribute instructions to cause the performance of the one or more back-end and front-end tasks at wrist-wearable device 1102, AR glasses 1104, and/or HIPD 1106. In some aspects, a back-end task is a background processing task that is not perceptible by the user (e.g., rendering content, decompression, compression, etc.), and a front-end task is a user-facing task that is perceptible to the user (e.g., presenting information to the user, providing feedback to the user, etc.). HIPD 1106 can perform the back-end tasks and provide wrist-wearable device 1102 and/or AR glasses 1104 operational data corresponding to the performed back-end tasks such that wrist-wearable device 1102 and/or AR glasses 1104 can perform the front-end tasks. In this way, HIPD 1106, which has more computational resources and greater thermal headroom than wrist-wearable device 1102 and/or AR glasses 1104, performs computationally intensive tasks and reduces the computer resource utilization and/or power usage of wrist-wearable device 1102 and/or AR glasses 1104.

In the example shown by first AR system 1100, HIPD 1106 identifies one or more back-end tasks and front-end tasks associated with a user request to initiate an AR video call with one or more other users (represented by avatar 1110 and the digital representation of contact 1112) and distributes instructions to cause the performance of the one or more back-end tasks and front-end tasks. In particular, HIPD 1106 performs back-end tasks for processing and/or rendering image data (and other data) associated with the AR video call and provides operational data associated with the performed back-end tasks to AR glasses 1104 such that the AR glasses 1104 perform front-end tasks for presenting the AR video call (e.g., presenting avatar 1110 and digital representation of contact 1112).

In some aspects, HIPD 1106 can operate as a focal or anchor point for causing the presentation of information. This allows user 1108 to be generally aware of where information is presented. For example, as shown in first AR system 1100, avatar 1110 and the digital representation of contact 1112 are presented above HIPD 1106. In particular, HIPD 1106 and AR glasses 1104 operate in conjunction to determine a location for presenting avatar 1110 and the digital representation of contact 1112. In some aspects, information can be presented a predetermined distance from HIPD 1106 (e.g., within 5 meters). For example, as shown in first AR system 1100, virtual object 1114 is presented on the desk some distance from HIPD 1106. Similar to the above example, HIPD 1106 and AR glasses 1104 can operate in conjunction to determine a location for presenting virtual object 1114. Alternatively, in some aspects, presentation of information is not bound by HIPD 1106. More specifically, avatar 1110, digital representation of contact 1112, and virtual object 1114 do not have to be presented within a predetermined distance of HIPD 1106.

User inputs provided at wrist-wearable device 1102, AR glasses 1104, and/or HIPD 1106 are coordinated such that the user can use any device to initiate, continue, and/or complete an operation. For example, user 1108 can provide a user input to AR glasses 1104 to cause AR glasses 1104 to present virtual object 1114 and, while virtual object 1114 is presented by AR glasses 1104, user 1108 can provide one or more hand gestures via wrist-wearable device 1102 to interact and/or manipulate virtual object 1114.

FIG. 12 shows a user 1208 wearing a wrist-wearable device 1202 and AR glasses 1204, and holding an HIPD 1206. In second AR system 1200, the wrist-wearable device 1202, AR glasses 1204, and/or HIPD 1206 are used to receive and/or provide one or more messages to a contact of user 1208. In particular, wrist-wearable device 1202, AR glasses 1204, and/or HIPD 1206 detect and coordinate one or more user inputs to initiate a messaging application and prepare a response to a received message via the messaging application.

In some aspects, user 1208 initiates, via a user input, an application on wrist-wearable device 1202, AR glasses 1204, and/or HIPD 1206 that causes the application to initiate on at least one device. For example, in second AR system 1200, user 1208 performs a hand gesture associated with a command for initiating a messaging application (represented by messaging user interface 1216), wrist-wearable device 1202 detects the hand gesture and, based on a determination that user 1208 is wearing AR glasses 1204, causes AR glasses 1204 to present a messaging user interface 1216 of the messaging application. AR glasses 1204 can present messaging user interface 1216 to user 1208 via its display (e.g., as shown by a field of view 1218 of user 1208). In some aspects, the application is initiated and executed on the device (e.g., wrist-wearable device 1202, AR glasses 1204, and/or HIPD 1206) that detects the user input to initiate the application, and the device provides another device operational data to cause the presentation of the messaging application. For example, wrist-wearable device 1202 can detect the user input to initiate a messaging application, initiate and run the messaging application, and provide operational data to AR glasses 1204 and/or HIPD 1206 to cause presentation of the messaging application. Alternatively, the application can be initiated and executed at a device other than the device that detected the user input. For example, wrist-wearable device 1202 can detect the hand gesture associated with initiating the messaging application and cause HIPD 1206 to run the messaging application and coordinate the presentation of the messaging application.

Further, user 1208 can provide a user input provided at wrist-wearable device 1202, AR glasses 1204, and/or HIPD 1206 to continue and/or complete an operation initiated at another device. For example, after initiating the messaging application via wrist-wearable device 1202 and while AR glasses 1204 present messaging user interface 1216, user 1208 can provide an input at HIPD 1206 to prepare a response (e.g., shown by the swipe gesture performed on HIPD 1206). Gestures performed by user 1208 on HIPD 1206 can be provided and/or displayed on another device. For example, a swipe gestured performed on HIPD 1206 is displayed on a virtual keyboard of messaging user interface 1216 displayed by AR glasses 1204.

In some aspects, wrist-wearable device 1202, AR glasses 1204, HIPD 1206, and/or any other communicatively coupled device can present one or more notifications to user 1208. The notification can be an indication of a new message, an incoming call, an application update, a status update, etc. User 1208 can select the notification via wrist-wearable device 1202, AR glasses 1204, and/or HIPD 1206 and can cause presentation of an application or operation associated with the notification on at least one device. For example, user 1208 can receive a notification that a message was received at wrist-wearable device 1202, AR glasses 1204, HIPD 1206, and/or any other communicatively coupled device and can then provide a user input at wrist-wearable device 1202, AR glasses 1204, and/or HIPD 1206 to review the notification, and the device detecting the user input can cause an application associated with the notification to be initiated and/or presented at wrist-wearable device 1202, AR glasses 1204, and/or HIPD 1206.

While the above example describes coordinated inputs used to interact with a messaging application, user inputs can be coordinated to interact with any number of applications including, but not limited to, gaming applications, social media applications, camera applications, web-based applications, financial applications, etc. For example, AR glasses 1204 can present to user 1208 game application data, and HIPD 1206 can be used as a controller to provide inputs to the game. Similarly, user 1208 can use wrist-wearable device 1202 to initiate a camera of AR glasses 1204, and user 1308 can use wrist-wearable device 1202, AR glasses 1204, and/or HIPD 1206 to manipulate the image capture (e.g., zoom in or out, apply filters, etc.) and capture image data.

Users may interact with the devices disclosed herein in a variety of ways. For example, as shown in FIGS. 13A and 13B, a user 1308 may interact with an AR system 1300 by donning a VR headset 1350 while holding HIPD 1306 and wearing wrist-wearable device 1302. In this example, AR system 1300 may enable a user to interact with a game 1310 by swiping their arm. One or more of VR headset 1350, HIPD 1306, and wrist-wearable device 1302 may detect this gesture and, in response, may display a sword strike in game 1310. Similarly, in FIGS. 14A and 14B, a user 1408 may interact with an AR system 1400 by donning a VR headset 1420 while wearing haptic device 1460 and wrist-wearable device 1430. In this example, AR system 1400 may enable a user to interact with a game 1410 by swiping their arm. One or more of VR headset 1420, haptic device 1460, and wrist-wearable device 1430 may detect this gesture and, in response, may display a spell being cast in game 1310.

Having discussed example AR systems, devices for interacting with such AR systems and other computing systems more generally will now be discussed in greater detail. Some explanations of devices and components that can be included in some or all of the example devices discussed below are explained herein for ease of reference. Certain types of the components described below may be more suitable for a particular set of devices, and less suitable for a different set of devices. But subsequent reference to the components explained here should be considered to be encompassed by the descriptions provided.

In some aspects discussed below, example devices and systems, including electronic devices and systems, will be addressed. Such example devices and systems are not intended to be limiting, and one of skill in the art will understand that alternative devices and systems to the example devices and systems described herein may be used to perform the operations and construct the systems and devices that are described herein.

An electronic device may be a device that uses electrical energy to perform a specific function. An electronic device can be any physical object that contains electronic components such as transistors, resistors, capacitors, diodes, and integrated circuits. Examples of electronic devices include smartphones, laptops, digital cameras, televisions, gaming consoles, and music players, as well as the example electronic devices discussed herein. As described herein, an intermediary electronic device may be a device that sits between two other electronic devices and/or a subset of components of one or more electronic devices and facilitates communication, data processing, and/or data transfer between the respective electronic devices and/or electronic components.

An integrated circuit may be an electronic device made up of multiple interconnected electronic components such as transistors, resistors, and capacitors. These components may be etched onto a small piece of semiconductor material, such as silicon. Integrated circuits may include analog integrated circuits, digital integrated circuits, mixed signal integrated circuits, and/or any other suitable type or form of integrated circuit. Examples of integrated circuits include application-specific integrated circuits (ASICs), processing units, central processing units (CPUs), co-processors, and accelerators.

Analog integrated circuits, such as sensors, power management circuits, and operational amplifiers, may process continuous signals and perform analog functions such as amplification, active filtering, demodulation, and mixing. Examples of analog integrated circuits include linear integrated circuits and radio frequency circuits.

Digital integrated circuits, which may be referred to as logic integrated circuits, may include microprocessors, microcontrollers, memory chips, interfaces, power management circuits, programmable devices, and/or any other suitable type or form of integrated circuit. In some aspects, examples of integrated circuits include central processing units (CPUs),

Processing units, such as CPUs, may be electronic components that are responsible for executing instructions and controlling the operation of an electronic device (e.g., a computer). There are various types of processors that may be used interchangeably, or may be specifically required, by aspects described herein. For example, a processor may be: (i) a general processor designed to perform a wide range of tasks, such as running software applications, managing operating systems, and performing arithmetic and logical operations; (ii) a microcontroller designed for specific tasks such as controlling electronic devices, sensors, and motors; (iii) an accelerator, such as a graphics processing unit (GPU), designed to accelerate the creation and rendering of images, videos, and animations (e.g., virtual-reality animations, such as three-dimensional modeling); (iv) a field-programmable gate array (FPGA) that can be programmed and reconfigured after manufacturing and/or can be customized to perform specific tasks, such as signal processing, cryptography, and machine learning; and/or (v) a digital signal processor (DSP) designed to perform mathematical operations on signals such as audio, video, and radio waves. One or more processors of one or more electronic devices may be used in various aspects described herein.

Memory generally refers to electronic components in a computer or electronic device that store data and instructions for the processor to access and manipulate. Examples of memory can include: (i) random access memory (RAM) configured to store data and instructions temporarily; (ii) read-only memory (ROM) configured to store data and instructions permanently (e.g., one or more portions of system firmware, and/or boot loaders) and/or semi-permanently; (iii) flash memory, which can be configured to store data in electronic devices (e.g., USB drives, memory cards, and/or solid-state drives (SSDs)); and/or (iv) cache memory configured to temporarily store frequently accessed data and instructions. Memory, as described herein, can store structured data (e.g., SQL databases, MongoDB databases, GraphQL data, JSON data, etc.). Other examples of data stored in memory can include (i) profile data, including user account data, user settings, and/or other user data stored by the user, (ii) sensor data detected and/or otherwise obtained by one or more sensors, (iii) media content data including stored image data, audio data, documents, and the like, (iv) application data, which can include data collected and/or otherwise obtained and stored during use of an application, and/or any other types of data described herein.

Controllers may be electronic components that manage and coordinate the operation of other components within an electronic device (e.g., controlling inputs, processing data, and/or generating outputs). Examples of controllers can include: (i) microcontrollers, including small, low-power controllers that are commonly used in embedded systems and Internet of Things (IoT) devices; (ii) programmable logic controllers (PLCs) that may be configured to be used in industrial automation systems to control and monitor manufacturing processes; (iii) system-on-a-chip (SoC) controllers that integrate multiple components such as processors, memory, I/O interfaces, and other peripherals into a single chip; and/or (iv) DSPs.

A power system of an electronic device may be configured to convert incoming electrical power into a form that can be used to operate the device. A power system can include various components, such as (i) a power source, which can be an alternating current (AC) adapter or a direct current (DC) adapter power supply, (ii) a charger input, which can be configured to use a wired and/or wireless connection (which may be part of a peripheral interface, such as a USB, micro-USB interface, near-field magnetic coupling, magnetic inductive and magnetic resonance charging, and/or radio frequency (RF) charging), (iii) a power-management integrated circuit, configured to distribute power to various components of the device and to ensure that the device operates within safe limits (e.g., regulating voltage, controlling current flow, and/or managing heat dissipation), and/or (iv) a battery configured to store power to provide usable power to components of one or more electronic devices.

Peripheral interfaces may be electronic components (e.g., of electronic devices) that allow electronic devices to communicate with other devices or peripherals and can provide the ability to input and output data and signals. Examples of peripheral interfaces can include (i) universal serial bus (USB) and/or micro-USB interfaces configured for connecting devices to an electronic device, (ii) Bluetooth interfaces configured to allow devices to communicate with each other, including Bluetooth low energy (BLE), (iii) near field communication (NFC) interfaces configured to be short-range wireless interfaces for operations such as access control, (iv) POGO pins, which may be small, spring-loaded pins configured to provide a charging interface, (v) wireless charging interfaces, (vi) GPS interfaces, (vii) Wi-Fi interfaces for providing a connection between a device and a wireless network, and/or (viii) sensor interfaces.

Sensors may be electronic components (e.g., in and/or otherwise in electronic communication with electronic devices, such as wearable devices) configured to detect physical and environmental changes and generate electrical signals. Examples of sensors can include (i) imaging sensors for collecting imaging data (e.g., including one or more cameras disposed on a respective electronic device), (ii) biopotential-signal sensors, (iii) inertial measurement units (e.g., IMUs) for detecting, for example, angular rate, force, magnetic field, and/or changes in acceleration, (iv) heart rate sensors for measuring a user's heart rate, (v) SpO2 sensors for measuring blood oxygen saturation and/or other biometric data of a user, (vi) capacitive sensors for detecting changes in potential at a portion of a user's body (e.g., a sensor-skin interface), and/or (vii) light sensors (e.g., time-of-flight sensors, infrared light sensors, visible light sensors, etc.).

Biopotential-signal-sensing components may be devices used to measure electrical activity within the body (e.g., biopotential-signal sensors). Some types of biopotential-signal sensors include (i) electroencephalography (EEG) sensors configured to measure electrical activity in the brain to diagnose neurological disorders, (ii) electrocardiography (ECG or EKG) sensors configured to measure electrical activity of the heart to diagnose heart problems, (iii) electromyography (EMG) sensors configured to measure the electrical activity of muscles and to diagnose neuromuscular disorders, and (iv) electrooculography (EOG) sensors configure to measure the electrical activity of eye muscles to detect eye movement and diagnose eye disorders.

An application stored in memory of an electronic device (e.g., software) may include instructions stored in the memory. Examples of such applications include (i) games, (ii) word processors, (iii) messaging applications, (iv) media-streaming applications, (v) financial applications, (vi) calendars. (vii) clocks, and (viii) communication interface modules for enabling wired and/or wireless connections between different respective electronic devices (e.g., IEEE 1702.15.4, Wi-Fi, ZigBee, 6LoWPAN, Thread, Z-Wave, Bluetooth Smart, ISA 100.11a, WirelessHART, or MiWi), custom or standard wired protocols (e.g., Ethernet or HomePlug), and/or any other suitable communication protocols).

A communication interface may be a mechanism that enables different systems or devices to exchange information and data with each other, including hardware, software, or a combination of both hardware and software. For example, a communication interface can refer to a physical connector and/or port on a device that enables communication with other devices (e.g., USB, Ethernet, HDMI, Bluetooth). In some aspects, a communication interface can refer to a software layer that enables different software programs to communicate with each other (e.g., application programming interfaces (APIs), protocols like HTTP and TCP/IP, etc.).

A graphics module may be a component or software module that is designed to handle graphical operations and/or processes and can include a hardware module and/or a software module.

Non-transitory computer-readable storage media may be physical devices or storage media that can be used to store electronic data in a non-transitory form (e.g., such that the data is stored permanently until it is intentionally deleted or modified).

FIGS. 15 and 16 illustrate an example wrist-wearable device 1500 and an example computer system 1600, in accordance with some aspects. Wrist-wearable device 1500 is an instance of wearable device 1102 described in FIG. 11 herein, such that the wearable device 1102 should be understood to have the features of the wrist-wearable device 1500 and vice versa. FIG. 16 illustrates components of the wrist-wearable device 1500, which can be used individually or in combination, including combinations that include other electronic devices and/or electronic components.

FIG. 15 shows a wearable band 1510 and a watch body 1520 (or capsule) being coupled, as discussed below, to form wrist-wearable device 1500. Wrist-wearable device 1500 can perform various functions and/or operations associated with navigating through user interfaces and selectively opening applications as well as the functions and/or operations described above with reference to FIGS. 11-14B.

As will be described in more detail below, operations executed by wrist-wearable device 1500 can include (i) presenting content to a user (e.g., displaying visual content via a display 1505), (ii) detecting (e.g., sensing) user input (e.g., sensing a touch on peripheral button 1523 and/or at a touch screen of the display 1505, a hand gesture detected by sensors (e.g., biopotential sensors)), (iii) sensing biometric data (e.g., neuromuscular signals, heart rate, temperature, sleep, etc.) via one or more sensors 1513, messaging (e.g., text, speech, video, etc.); image capture via one or more imaging devices or cameras 1525, wireless communications (e.g., cellular, near field, Wi-Fi, personal area network, etc.), location determination, financial transactions, providing haptic feedback, providing alarms, providing notifications, providing biometric authentication, providing health monitoring, providing sleep monitoring, etc.

The above-example functions can be executed independently in watch body 1520, independently in wearable band 1510, and/or via an electronic communication between watch body 1520 and wearable band 1510. In some aspects, functions can be executed on wrist-wearable device 1500 while an AR environment is being presented (e.g., via one of AR systems 1100 to 1400). The wearable devices described herein can also be used with other types of AR environments.

Wearable band 1510 can be configured to be worn by a user such that an inner surface of a wearable structure 1511 of wearable band 1510 is in contact with the user's skin. In this example, when worn by a user, sensors 1513 may contact the user's skin. In some examples, one or more of sensors 1513 can sense biometric data such as a user's heart rate, a saturated oxygen level, temperature, sweat level, neuromuscular signals, or a combination thereof. One or more of sensors 1513 can also sense data about a user's environment including a user's motion, altitude, location, orientation, gait, acceleration, position, or a combination thereof. In some aspect, one or more of sensors 1513 can be configured to track a position and/or motion of wearable band 1510. One or more of sensors 1513 can include any of the sensors defined above and/or discussed below with respect to FIG. 15.

One or more of sensors 1513 can be distributed on an inside and/or an outside surface of wearable band 1510. In some aspects, one or more of sensors 1513 are uniformly spaced along wearable band 1510. Alternatively, in some aspects, one or more of sensors 1513 are positioned at distinct points along wearable band 1510. As shown in FIG. 15, one or more of sensors 1513 can be the same or distinct. For example, in some aspects, one or more of sensors 1513 can be shaped as a pill (e.g., sensor 1513a), an oval, a circle a square, an oblong (e.g., sensor 1513c) and/or any other shape that maintains contact with the user's skin (e.g., such that neuromuscular signal and/or other biometric data can be accurately measured at the user's skin). In some aspects, one or more sensors of 1513 are aligned to form pairs of sensors (e.g., for sensing neuromuscular signals based on differential sensing within each respective sensor). For example, sensor 1513b may be aligned with an adjacent sensor to form sensor pair 1514a and sensor 1513d may be aligned with an adjacent sensor to form sensor pair 1514b. In some aspects, wearable band 1510 does not have a sensor pair. Alternatively, in some aspects, wearable band 1510 has a predetermined number of sensor pairs (one pair of sensors, three pairs of sensors, four pairs of sensors, six pairs of sensors, sixteen pairs of sensors, etc.).

Wearable band 1510 can include any suitable number of sensors 1513. In some aspects, the number and arrangement of sensors 1513 depends on the particular application for which wearable band 1510 is used. For instance, wearable band 1510 can be configured as an armband, wristband, or chest-band that include a plurality of sensors 1513 with different number of sensors 1513, a variety of types of individual sensors with the plurality of sensors 1513, and different arrangements for each use case, such as medical use cases as compared to gaming or general day-to-day use cases.

In accordance with some aspects, wearable band 1510 further includes an electrical ground electrode and a shielding electrode. The electrical ground and shielding electrodes, like the sensors 1513, can be distributed on the inside surface of the wearable band 1510 such that they contact a portion of the user's skin. For example, the electrical ground and shielding electrodes can be at an inside surface of a coupling mechanism 1516 or an inside surface of a wearable structure 1511. The electrical ground and shielding electrodes can be formed and/or use the same components as sensors 1513. In some aspects, wearable band 1510 includes more than one electrical ground electrode and more than one shielding electrode.

Sensors 1513 can be formed as part of wearable structure 1511 of wearable band 1510. In some aspects, sensors 1513 are flush or substantially flush with wearable structure 1511 such that they do not extend beyond the surface of wearable structure 1511. While flush with wearable structure 1511, sensors 1513 are still configured to contact the user's skin (e.g., via a skin-contacting surface). Alternatively, in some aspects, sensors 1513 extend beyond wearable structure 1511 a predetermined distance (e.g., 0.1-2 mm) to make contact and depress into the user's skin. In some aspect, sensors 1513 are coupled to an actuator (not shown) configured to adjust an extension height (e.g., a distance from the surface of wearable structure 1511) of sensors 1513 such that sensors 1513 make contact and depress into the user's skin. In some aspects, the actuators adjust the extension height between 0.01mm-1.2 mm. This may allow a the user to customize the positioning of sensors 1513 to improve the overall comfort of the wearable band 1510 when worn while still allowing sensors 1513 to contact the user's skin. In some aspects, sensors 1513 are indistinguishable from wearable structure 1511 when worn by the user.

Wearable structure 1511 can be formed of an elastic material, elastomers, etc., configured to be stretched and fitted to be worn by the user. In some aspects, wearable structure 1511 is a textile or woven fabric. As described above, sensors 1513 can be formed as part of a wearable structure 1511. For example, sensors 1513 can be molded into the wearable structure 1511, be integrated into a woven fabric (e.g., sensors 1513 can be sewn into the fabric and mimic the pliability of fabric and can and/or be constructed from a series woven strands of fabric).

Wearable structure 1511 can include flexible electronic connectors that interconnect sensors 1513, the electronic circuitry, and/or other electronic components (described below in reference to FIG. 16) that are enclosed in wearable band 1510. In some aspects, the flexible electronic connectors are configured to interconnect sensors 1513, the electronic circuitry, and/or other electronic components of wearable band 1510 with respective sensors and/or other electronic components of another electronic device (e.g., watch body 1520). The flexible electronic connectors are configured to move with wearable structure 1511 such that the user adjustment to wearable structure 1511 (e.g., resizing, pulling, folding, etc.) does not stress or strain the electrical coupling of components of wearable band 1510.

As described above, wearable band 1510 is configured to be worn by a user. In particular, wearable band 1510 can be shaped or otherwise manipulated to be worn by a user. For example, wearable band 1510 can be shaped to have a substantially circular shape such that it can be configured to be worn on the user's lower arm or wrist. Alternatively, wearable band 1510 can be shaped to be worn on another body part of the user, such as the user's upper arm (e.g., around a bicep), forearm, chest, legs, etc. Wearable band 1510 can include a retaining mechanism 1512 (e.g., a buckle, a hook and loop fastener, etc.) for securing wearable band 1510 to the user's wrist or other body part. While wearable band 1510 is worn by the user, sensors 1513 sense data (referred to as sensor data) from the user's skin. In some examples, sensors 1513 of wearable band 1510 obtain (e.g., sense and record) neuromuscular signals.

The sensed data (e.g., sensed neuromuscular signals) can be used to detect and/or determine the user's intention to perform certain motor actions. In some examples, sensors 1513 may sense and record neuromuscular signals from the user as the user performs muscular activations (e.g., movements, gestures, etc.). The detected and/or determined motor actions (e.g., phalange (or digit) movements, wrist movements, hand movements, and/or other muscle intentions) can be used to determine control commands or control information (instructions to perform certain commands after the data is sensed) for causing a computing device to perform one or more input commands. For example, the sensed neuromuscular signals can be used to control certain user interfaces displayed on display 1505 of wrist-wearable device 1500 and/or can be transmitted to a device responsible for rendering an artificial-reality environment (e.g., a head-mounted display) to perform an action in an associated artificial-reality environment, such as to control the motion of a virtual device displayed to the user. The muscular activations performed by the user can include static gestures, such as placing the user's hand palm down on a table, dynamic gestures, such as grasping a physical or virtual object, and covert gestures that are imperceptible to another person, such as slightly tensing a joint by co-contracting opposing muscles or using sub-muscular activations. The muscular activations performed by the user can include symbolic gestures (e.g., gestures mapped to other gestures, interactions, or commands, for example, based on a gesture vocabulary that specifies the mapping of gestures to commands).

The sensor data sensed by sensors 1513 can be used to provide a user with an enhanced interaction with a physical object (e.g., devices communicatively coupled with wearable band 1510) and/or a virtual object in an artificial-reality application generated by an artificial-reality system (e.g., user interface objects presented on the display 1505, or another computing device (e.g., a smartphone)).

In some aspects, wearable band 1510 includes one or more haptic devices 1646 (e.g., a vibratory haptic actuator) that are configured to provide haptic feedback (e.g., a cutaneous and/or kinesthetic sensation, etc.) to the user's skin. Sensors 1513 and/or haptic devices 1646 (shown in FIG. 16) can be configured to operate in conjunction with multiple applications including, without limitation, health monitoring, social media, games, and artificial reality (e.g., the applications associated with artificial reality).

Wearable band 1510 can also include coupling mechanism 1516 for detachably coupling a capsule (e.g., a computing unit) or watch body 1520 (via a coupling surface of the watch body 1520) to wearable band 1510. For example, a cradle or a shape of coupling mechanism 1516 can correspond to shape of watch body 1520 of wrist-wearable device 1500. In particular, coupling mechanism 1516 can be configured to receive a coupling surface proximate to the bottom side of watch body 1520 (e.g., a side opposite to a front side of watch body 1520 where display 1505 is located), such that a user can push watch body 1520 downward into coupling mechanism 1516 to attach watch body 1520 to coupling mechanism 1516. In some aspects, coupling mechanism 1516 can be configured to receive a top side of the watch body 1520 (e.g., a side proximate to the front side of watch body 1520 where display 1505 is located) that is pushed upward into the cradle, as opposed to being pushed downward into coupling mechanism 1516. In some aspects, coupling mechanism 1516 is an integrated component of wearable band 1510 such that wearable band 1510 and coupling mechanism 1516 are a single unitary structure. In some aspects, coupling mechanism 1516 is a type of frame or shell that allows watch body 1520 coupling surface to be retained within or on wearable band 1510 coupling mechanism 1516 (e.g., a cradle, a tracker band, a support base, a clasp, etc.).

Coupling mechanism 1516 can allow for watch body 1520 to be detachably coupled to the wearable band 1510 through a friction fit, magnetic coupling, a rotation-based connector, a shear-pin coupler, a retention spring, one or more magnets, a clip, a pin shaft, a hook and loop fastener, or a combination thereof. A user can perform any type of motion to couple the watch body 1520 to wearable band 1510 and to decouple the watch body 1520 from the wearable band 1510. For example, a user can twist, slide, turn, push, pull, or rotate watch body 1520 relative to wearable band 1510, or a combination thereof, to attach watch body 1520 to wearable band 1510 and to detach watch body 1520 from wearable band 1510. Alternatively, as discussed below, in some aspects, the watch body 1520 can be decoupled from the wearable band 1510 by actuation of a release mechanism 1529.

Wearable band 1510 can be coupled with watch body 1520 to increase the functionality of wearable band 1510 (e.g., converting wearable band 1510 into wrist-wearable device 1500, adding an additional computing unit and/or battery to increase computational resources and/or a battery life of wearable band 1510, adding additional sensors to improve sensed data, etc.). As described above, wearable band 1510 and coupling mechanism 1516 are configured to operate independently (e.g., execute functions independently) from watch body 1520. For example, coupling mechanism 1516 can include one or more sensors 1513 that contact a user's skin when wearable band 1510 is worn by the user, with or without watch body 1520 and can provide sensor data for determining control commands.

A user can detach watch body 1520 from wearable band 1510 to reduce the encumbrance of wrist-wearable device 1500 to the user. For aspects in which watch body 1520 is removable, watch body 1520 can be referred to as a removable structure, such that in these aspects wrist-wearable device 1500 includes a wearable portion (e.g., wearable band 1510) and a removable structure (e.g., watch body 1520).

Turning to watch body 1520, in some examples watch body 1520 can have a substantially rectangular or circular shape. Watch body 1520 is configured to be worn by the user on their wrist or on another body part. More specifically, watch body 1520 is sized to be easily carried by the user, attached on a portion of the user's clothing, and/or coupled to wearable band 1510 (forming the wrist-wearable device 1500). As described above, watch body 1520 can have a shape corresponding to coupling mechanism 1516 of wearable band 1510. In some aspects, watch body 1520 includes a single release mechanism 1529 or multiple release mechanisms (e.g., two release mechanisms 1529 positioned on opposing sides of watch body 1520, such as spring-loaded buttons) for decoupling watch body 1520 from wearable band 1510. Release mechanism 1529 can include, without limitation, a button, a knob, a plunger, a handle, a lever, a fastener, a clasp, a dial, a latch, or a combination thereof.

A user can actuate release mechanism 1529 by pushing, turning, lifting, depressing, shifting, or performing other actions on release mechanism 1529. Actuation of release mechanism 1529 can release (e.g., decouple) watch body 1520 from coupling mechanism 1516 of wearable band 1510, allowing the user to use watch body 1520 independently from wearable band 1510 and vice versa. For example, decoupling watch body 1520 from wearable band 1510 can allow a user to capture images using rear-facing camera 1525b. Although release mechanism 1529 is shown positioned at a corner of watch body 1520, release mechanism 1529 can be positioned anywhere on watch body 1520 that is convenient for the user to actuate. In addition, in some aspects, wearable band 1510 can also include a respective release mechanism for decoupling watch body 1520 from coupling mechanism 1516. In some aspects, release mechanism 1529 is optional and watch body 1520 can be decoupled from coupling mechanism 1516 as described above (e.g., via twisting, rotating, etc.).

Watch body 1520 can include one or more peripheral buttons 1523 and 1527 for performing various operations at watch body 1520. For example, peripheral buttons 1523 and 1527 can be used to turn on or wake (e.g., transition from a sleep state to an active state) display 1505, unlock watch body 1520, increase or decrease a volume, increase or decrease a brightness, interact with one or more applications, interact with one or more user interfaces, etc. Additionally or alternatively, in some aspects, display 1505 operates as a touch screen and allows the user to provide one or more inputs for interacting with watch body 1520.

In some aspects, watch body 1520 includes one or more sensors 1521. Sensors 1521 of watch body 1520 can be the same or distinct from sensors 1513 of wearable band 1510. Sensors 1521 of watch body 1520 can be distributed on an inside and/or an outside surface of watch body 1520. In some aspects, sensors 1521 are configured to contact a user's skin when watch body 1520 is worn by the user. For example, sensors 1521 can be placed on the bottom side of watch body 1520 and coupling mechanism 1516 can be a cradle with an opening that allows the bottom side of watch body 1520 to directly contact the user's skin. Alternatively, in some aspects, watch body 1520 does not include sensors that are configured to contact the user's skin (e.g., including sensors internal and/or external to the watch body 1520 that are configured to sense data of watch body 1520 and the surrounding environment). In some aspects, sensors 1521 are configured to track a position and/or motion of watch body 1520.

Watch body 1520 and wearable band 1510 can share data using a wired communication method (e.g., a Universal Asynchronous Receiver/Transmitter (UART), a USB transceiver, etc.) and/or a wireless communication method (e.g., near field communication, Bluetooth, etc.). For example, watch body 1520 and wearable band 1510 can share data sensed by sensors 1513 and 1521, as well as application and device specific information (e.g., active and/or available applications, output devices (e.g., displays, speakers, etc.), input devices (e.g., touch screens, microphones, imaging sensors, etc.).

In some aspects, watch body 1520 can include, without limitation, a front-facing camera 1525a and/or a rear-facing camera 1525b, sensors 1521 (e.g., a biometric sensor, an IMU, a heart rate sensor, a saturated oxygen sensor, a neuromuscular signal sensor, an altimeter sensor, a temperature sensor, a bioimpedance sensor, a pedometer sensor, an optical sensor (e.g., imaging sensor 1663), a touch sensor, a sweat sensor, etc.). In some aspects, watch body 1520 can include one or more haptic devices 1676 (e.g., a vibratory haptic actuator) that is configured to provide haptic feedback (e.g., a cutaneous and/or kinesthetic sensation, etc.) to the user. Sensors 1621 and/or haptic device 1676 can also be configured to operate in conjunction with multiple applications including, without limitation, health monitoring applications, social media applications, game applications, and artificial reality applications (e.g., the applications associated with artificial reality).

As described above, watch body 1520 and wearable band 1510, when coupled, can form wrist-wearable device 1500. When coupled, watch body 1520 and wearable band 1510 may operate as a single device to execute functions (operations, detections, communications, etc.) described herein. In some aspects, each device may be provided with particular instructions for performing the one or more operations of wrist-wearable device 1500. For example, in accordance with a determination that watch body 1520 does not include neuromuscular signal sensors, wearable band 1510 can include alternative instructions for performing associated instructions (e.g., providing sensed neuromuscular signal data to watch body 1520 via a different electronic device). Operations of wrist-wearable device 1500 can be performed by watch body 1520 alone or in conjunction with wearable band 1510 (e.g., via respective processors and/or hardware components) and vice versa. In some aspects, operations of wrist-wearable device 1500, watch body 1520, and/or wearable band 1510 can be performed in conjunction with one or more processors and/or hardware components.

As described below with reference to the block diagram of FIG. 16, wearable band 1510 and/or watch body 1520 can each include independent resources required to independently execute functions. For example, wearable band 1510 and/or watch body 1520 can each include a power source (e.g., a battery), a memory, data storage, a processor (e.g., a central processing unit (CPU)), communications, a light source, and/or input/output devices.

FIG. 16 shows block diagrams of a computing system 1630 corresponding to wearable band 1510 and a computing system 1660 corresponding to watch body 1520 according to some aspects. Computing system 1600 of wrist-wearable device 1500 may include a combination of components of wearable band computing system 1630 and watch body computing system 1660, in accordance with some aspects.

Watch body 1520 and/or wearable band 1510 can include one or more components shown in watch body computing system 1660. In some aspects, a single integrated circuit may include all or a substantial portion of the components of watch body computing system 1660 included in a single integrated circuit. Alternatively, in some aspects, components of the watch body computing system 1660 may be included in a plurality of integrated circuits that are communicatively coupled. In some aspects, watch body computing system 1660 may be configured to couple (e.g., via a wired or wireless connection) with wearable band computing system 1630, which may allow the computing systems to share components, distribute tasks, and/or perform other operations described herein (individually or as a single device).

Watch body computing system 1660 can include one or more processors 1679, a controller 1677, a peripherals interface 1661, a power system 1695, and memory (e.g., a memory 1680).

Power system 1695 can include a charger input 1696, a power-management integrated circuit (PMIC) 1697, and a battery 1698. In some aspects, a watch body 1520 and a wearable band 1510 can have respective batteries (e.g., battery 1698 and 1659) and can share power with each other. Watch body 1520 and wearable band 1510 can receive a charge using a variety of techniques. In some aspects, watch body 1520 and wearable band 1510 can use a wired charging assembly (e.g., power cords) to receive the charge. Alternatively, or in addition, watch body 1520 and/or wearable band 1510 can be configured for wireless charging. For example, a portable charging device can be designed to mate with a portion of watch body 1520 and/or wearable band 1510 and wirelessly deliver usable power to battery 1698 of watch body 1520 and/or battery 1659 of wearable band 1510. Watch body 1520 and wearable band 1510 can have independent power systems (e.g., power system 1695 and 1656, respectively) to enable each to operate independently. Watch body 1520 and wearable band 1510 can also share power (e.g., one can charge the other) via respective PMICs (e.g., PMICs 1697 and 1658) and charger inputs (e.g., 1657 and 1696) that can share power over power and ground conductors and/or over wireless charging antennas.

In some aspects, peripherals interface 1661 can include one or more sensors 1621. Sensors 1621 can include one or more coupling sensors 1662 for detecting when watch body 1520 is coupled with another electronic device (e.g., a wearable band 1510). Sensors 1621 can include one or more imaging sensors 1663 (e.g., one or more of cameras 1625, and/or separate imaging sensors 1663 (e.g., thermal-imaging sensors)). In some aspects, sensors 1621 can include one or more SpO2 sensors 1664. In some aspects, sensors 1621 can include one or more biopotential-signal sensors (e.g., EMG sensors 1665, which may be disposed on an interior, user-facing portion of watch body 1520 and/or wearable band 1510). In some aspects, sensors 1621 may include one or more capacitive sensors 1666. In some aspects, sensors 1621 may include one or more heart rate sensors 1667. In some aspects, sensors 1621 may include one or more IMU sensors 1668. In some aspects, one or more IMU sensors 1668 can be configured to detect movement of a user's hand or other location where watch body 1520 is placed or held.

In some aspects, one or more of sensors 1621 may provide an example human-machine interface. For example, a set of neuromuscular sensors, such as EMG sensors 1665, may be arranged circumferentially around wearable band 1510 with an interior surface of EMG sensors 1665 being configured to contact a user's skin. Any suitable number of neuromuscular sensors may be used (e.g., between 2 and 20 sensors). The number and arrangement of neuromuscular sensors may depend on the particular application for which the wearable device is used. For example, wearable band 1510 can be used to generate control information for controlling an augmented reality system, a robot, controlling a vehicle, scrolling through text, controlling a virtual avatar, or any other suitable control task.

In some aspects, neuromuscular sensors may be coupled together using flexible electronics incorporated into the wireless device, and the output of one or more of the sensing components can be optionally processed using hardware signal processing circuitry (e.g., to perform amplification, filtering, and/or rectification). In other aspects, at least some signal processing of the output of the sensing components can be performed in software such as processors 1679. Thus, signal processing of signals sampled by the sensors can be performed in hardware, software, or by any suitable combination of hardware and software, as aspects of the technology described herein are not limited in this respect.

Neuromuscular signals may be processed in a variety of ways. For example, the output of EMG sensors 1665 may be provided to an analog front end, which may be configured to perform analog processing (e.g., amplification, noise reduction, filtering, etc.) on the recorded signals. The processed analog signals may then be provided to an analog-to-digital converter, which may convert the analog signals to digital signals that can be processed by one or more computer processors. Furthermore, although this example is as discussed in the context of interfaces with EMG sensors, the aspects described herein can also be implemented in wearable interfaces with other types of sensors including, but not limited to, mechanomyography (MMG) sensors, sonomyography (SMG) sensors, and electrical impedance tomography (EIT) sensors.

In some aspects, peripherals interface 1661 includes a near-field communication (NFC) component 1669, a global-position system (GPS) component 1670, a long-term evolution (LTE) component 1671, and/or a Wi-Fi and/or Bluetooth communication component 1672. In some aspects, peripherals interface 1661 includes one or more buttons 1673 (e.g., peripheral buttons 1523 and 1527 in FIG. 15), which, when selected by a user, cause operation to be performed at watch body 1520. In some aspects, the peripherals interface 1661 includes one or more indicators, such as a light emitting diode (LED), to provide a user with visual indicators (e.g., message received, low battery, active microphone and/or camera, etc.).

Watch body 1520 can include at least one display 1505 for displaying visual representations of information or data to a user, including user-interface elements and/or three-dimensional virtual objects. The display can also include a touch screen for inputting user inputs, such as touch gestures, swipe gestures, and the like. Watch body 1520 can include at least one speaker 1674 and at least one microphone 1675 for providing audio signals to the user and receiving audio input from the user. The user can provide user inputs through microphone 1675 and can also receive audio output from speaker 1674 as part of a haptic event provided by haptic controller 1678. Watch body 1520 can include at least one camera 1625, including a front camera 1625a and a rear camera 1625b. Cameras 1625 can include ultra-wide-angle cameras, wide angle cameras, fish-eye cameras, spherical cameras, telephoto cameras, depth-sensing cameras, or other types of cameras.

Watch body computing system 1660 can include one or more haptic controllers 1678 and associated componentry (e.g., haptic devices 1676) for providing haptic events at watch body 1520 (e.g., a vibrating sensation or audio output in response to an event at the watch body 1520). Haptic controllers 1678 can communicate with one or more haptic devices 1676, such as electroacoustic devices, including a speaker of the one or more speakers 1674 and/or other audio components and/or electromechanical devices that convert energy into linear motion such as a motor, solenoid, electroactive polymer, piezoelectric actuator, electrostatic actuator, or other tactile output generating components (e.g., a component that converts electrical signals into tactile outputs on the device). Haptic controller 1678 can provide haptic events to that are capable of being sensed by a user of watch body 1520. In some aspects, one or more haptic controllers 1678 can receive input signals from an application of applications 1682.

In some aspects, wearable band computing system 1630 and/or watch body computing system 1660 can include memory 1680, which can be controlled by one or more memory controllers of controllers 1677. In some aspects, software components stored in memory 1680 include one or more applications 1682 configured to perform operations at the watch body 1520. In some aspects, one or more applications 1682 may include games, word processors, messaging applications, calling applications, web browsers, social media applications, media streaming applications, financial applications, calendars, clocks, etc. In some aspects, software components stored in memory 1680 include one or more communication interface modules 1683 as defined above. In some aspects, software components stored in memory 1680 include one or more graphics modules 1684 for rendering, encoding, and/or decoding audio and/or visual data and one or more data management modules 1685 for collecting, organizing, and/or providing access to data 1687 stored in memory 1680. In some aspects, one or more of applications 1682 and/or one or more modules can work in conjunction with one another to perform various tasks at the watch body 1520.

In some aspects, software components stored in memory 1680 can include one or more operating systems 1681 (e.g., a Linux-based operating system, an Android operating system, etc.). Memory 1680 can also include data 1687. Data 1687 can include profile data 1688A, sensor data 1689A, media content data 1690, and application data 1691.

It should be appreciated that watch body computing system 1660 is an example of a computing system within watch body 1520, and that watch body 1520 can have more or fewer components than shown in watch body computing system 1660, can combine two or more components, and/or can have a different configuration and/or arrangement of the components. The various components shown in watch body computing system 1660 are implemented in hardware, software, firmware, or a combination thereof, including one or more signal processing and/or application-specific integrated circuits.

Turning to the wearable band computing system 1630, one or more components that can be included in wearable band 1510 are shown. Wearable band computing system 1630 can include more or fewer components than shown in watch body computing system 1660, can combine two or more components, and/or can have a different configuration and/or arrangement of some or all of the components. In some aspects, all, or a substantial portion of the components of wearable band computing system 1630 are included in a single integrated circuit. Alternatively, in some aspects, components of wearable band computing system 1630 are included in a plurality of integrated circuits that are communicatively coupled. As described above, in some aspects, wearable band computing system 1630 is configured to couple (e.g., via a wired or wireless connection) with watch body computing system 1660, which allows the computing systems to share components, distribute tasks, and/or perform other operations described herein (individually or as a single device).

Wearable band computing system 1630, similar to watch body computing system 1660, can include one or more processors 1649, one or more controllers 1647 (including one or more haptics controllers 1648), a peripherals interface 1631 that can includes one or more sensors 1613 and other peripheral devices, a power source (e.g., a power system 1656), and memory (e.g., a memory 1650) that includes an operating system (e.g., an operating system 1651), data (e.g., data 1654 including profile data 1688B, sensor data 1689B, etc.), and one or more modules (e.g., a communications interface module 1652, a data management module 1653, etc.).

One or more of sensors 1613 can be analogous to sensors 1621 of watch body computing system 1660. For example, sensors 1613 can include one or more coupling sensors 1632, one or more SpO 2 sensors 1634, one or more EMG sensors 1635, one or more capacitive sensors 1636, one or more heart rate sensors 1637, and one or more IMU sensors 1638.

Peripherals interface 1631 can also include other components analogous to those included in peripherals interface 1661 of watch body computing system 1660, including an NFC component 1639, a GPS component 1640, an LTE component 1641, a Wi-Fi and/or Bluetooth communication component 1642, and/or one or more haptic devices 1646 as described above in reference to peripherals interface 1661. In some aspects, peripherals interface 1631 includes one or more buttons 1643, a display 1633, a speaker 1644, a microphone 1645, and a camera 1655. In some aspects, peripherals interface 1631 includes one or more indicators, such as an LED.

It should be appreciated that wearable band computing system 1630 is an example of a computing system within wearable band 1510, and that wearable band 1510 can have more or fewer components than shown in wearable band computing system 1630, combine two or more components, and/or have a different configuration and/or arrangement of the components. The various components shown in wearable band computing system 1630 can be implemented in one or more of a combination of hardware, software, or firmware, including one or more signal processing and/or application-specific integrated circuits.

Wrist-wearable device 1500 with respect to FIG. 15 is an example of wearable band 1510 and watch body 1520 coupled together, so wrist-wearable device 1500 will be understood to include the components shown and described for wearable band computing system 1630 and watch body computing system 1660. In some aspects, wrist-wearable device 1500 has a split architecture (e.g., a split mechanical architecture, a split electrical architecture, etc.) between watch body 1520 and wearable band 1510. In other words, all of the components shown in wearable band computing system 1630 and watch body computing system 1660 can be housed or otherwise disposed in a combined wrist-wearable device 1500 or within individual components of watch body 1520, wearable band 1510, and/or portions thereof (e.g., a coupling mechanism 1516 of wearable band 1510).

The techniques described above can be used with any device for sensing neuromuscular signals but could also be used with other types of wearable devices for sensing neuromuscular signals (such as body-wearable or head-wearable devices that might have neuromuscular sensors closer to the brain or spinal column).

In some aspects, wrist-wearable device 1500 can be used in conjunction with a head-wearable device (e.g., AR glasses 1700 and VR system 1810) and/or an HIPD, and wrist-wearable device 1500 can also be configured to be used to allow a user to control any aspect of the artificial reality (e.g., by using EMG-based gestures to control user interface objects in the artificial reality and/or by allowing a user to interact with the touchscreen on the wrist-wearable device to also control aspects of the artificial reality). Having thus described example wrist-wearable devices, attention will now be turned to example head-wearable devices, such AR glasses 1700 and VR headset 1810.

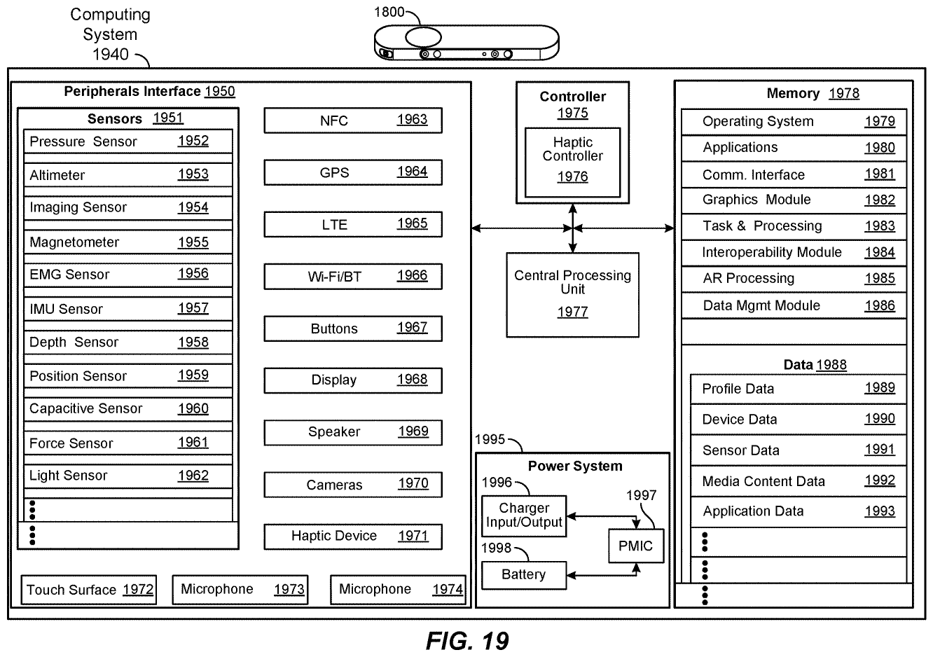

FIGS. 17 to 19 show example artificial-reality systems, which can be used as or in connection with wrist-wearable device 1500. In some aspects, AR system 1700 includes an eyewear device 1702, as shown in FIG. 17. In some aspects, VR system 1810 includes a head-mounted display (HMD) 1812, as shown in FIGS. 18A and 18B. In some aspects, AR system 1700 and VR system 1810 can include one or more analogous components (e.g., components for presenting interactive artificial-reality environments, such as processors, memory, and/or presentation devices, including one or more displays and/or one or more waveguides), some of which are described in more detail with respect to FIG. 19. As described herein, a head-wearable device can include components of eyewear device 1702 and/or head-mounted display 1812. Some aspects of head-wearable devices do not include any displays, including any of the displays described with respect to AR system 1700 and/or VR system 1810. While the example artificial-reality systems are respectively described herein as AR system 1700 and VR system 1810, either or both of the example AR systems described herein can be configured to present fully-immersive virtual-reality scenes presented in substantially all of a user's field of view or subtler augmented-reality scenes that are presented within a portion, less than all, of the user's field of view.

FIG. 17 show an example visual depiction of AR system 1700, including an eyewear device 1702 (which may also be described herein as augmented-reality glasses, and/or smart glasses). AR system 1700 can include additional electronic components that are not shown in FIG. 17, such as a wearable accessory device and/or an intermediary processing device, in electronic communication or otherwise configured to be used in conjunction with the eyewear device 1702. In some aspects, the wearable accessory device and/or the intermediary processing device may be configured to couple with eyewear device 1702 via a coupling mechanism in electronic communication with a coupling sensor 1924 (FIG. 19), where coupling sensor 1924 can detect when an electronic device becomes physically or electronically coupled with eyewear device 1702. In some aspects, eyewear device 1702 can be configured to couple to a housing 1990 (FIG. 19), which may include one or more additional coupling mechanisms configured to couple with additional accessory devices. The components shown in FIG. 17 can be implemented in hardware, software, firmware, or a combination thereof, including one or more signal-processing components and/or application-specific integrated circuits (ASICs).

Eyewear device 1702 includes mechanical glasses components, including a frame 1704 configured to hold one or more lenses (e.g., one or both lenses 1706-1 and 1706-2). One of ordinary skill in the art will appreciate that eyewear device 1702 can include additional mechanical components, such as hinges configured to allow portions of frame 1704 of eyewear device 1702 to be folded and unfolded, a bridge configured to span the gap between lenses 1706-1 and 1706-2 and rest on the user's nose, nose pads configured to rest on the bridge of the nose and provide support for eyewear device 1702, earpieces configured to rest on the user's ears and provide additional support for eyewear device 1702, temple arms configured to extend from the hinges to the earpieces of eyewear device 1702, and the like. One of ordinary skill in the art will further appreciate that some examples of AR system 1700 can include none of the mechanical components described herein. For example, smart contact lenses configured to present artificial reality to users may not include any components of eyewear device 1702.

Eyewear device 1702 includes electronic components, many of which will be described in more detail below with respect to FIG. 10. Some example electronic components are illustrated in FIG. 17, including acoustic sensors 1725-1, 1725-2, 1725-3, 1725-4, 1725-5, and 1725-6, which can be distributed along a substantial portion of the frame 1704 of eyewear device 1702. Eyewear device 1702 also includes a left camera 1739A and a right camera 1739B, which are located on different sides of the frame 1704. Eyewear device 1702 also includes a processor 1748 (or any other suitable type or form of integrated circuit) that is embedded into a portion of the frame 1704.

FIGS. 18A and 18B show a VR system 1810 that includes a head-mounted display (HMD) 1812 (e.g., also referred to herein as an artificial-reality headset, a head-wearable device, a VR headset, etc.), in accordance with some aspects. As noted, some artificial-reality systems (e.g., AR system 1700) may, instead of blending an artificial reality with actual reality, substantially replace one or more of a user's visual and/or other sensory perceptions of the real world with a virtual experience (e.g., AR systems 1300 and 1400).

HMD 1812 includes a front body 1814 and a frame 1816 (e.g., a strap or band) shaped to fit around a user's head. In some aspects, front body 1814 and/or frame 1816 include one or more electronic elements for facilitating presentation of and/or interactions with an AR and/or VR system (e.g., displays, IMUs, tracking emitter or detectors). In some aspects, HMD 1812 includes output audio transducers (e.g., an audio transducer 1818), as shown in FIG. 18B. In some aspects, one or more components, such as the output audio transducer(s) 1818 and frame 1816, can be configured to attach and detach (e.g., are detachably attachable) to HMD 1812 (e.g., a portion or all of frame 1816, and/or audio transducer 1818), as shown in FIG. 18B. In some aspects, coupling a detachable component to HMD 1812 causes the detachable component to come into electronic communication with HMD 1812.

FIGS. 18A and 18B also show that VR system 1810 includes one or more cameras, such as left camera 1839A and right camera 1839B, which can be analogous to left and right cameras 1739A and 1739B on frame 1704 of eyewear device 1702. In some aspects, VR system 1810 includes one or more additional cameras (e.g., cameras 1839C and 1839D), which can be configured to augment image data obtained by left and right cameras 1839A and 1839B by providing more information. For example, camera 1839C can be used to supply color information that is not discerned by cameras 1839A and 1839B. In some aspects, one or more of cameras 1839A to 1839D can include an optional IR cut filter configured to remove IR light from being received at the respective camera sensors.

FIG. 19 illustrates a computing system 1920 and an optional housing 1990, each of which show components that can be included in AR system 1700 and/or VR system 1810. In some aspects, more or fewer components can be included in optional housing 1990 depending on practical restraints of the respective AR system being described.

In some aspects, computing system 1920 can include one or more peripherals interfaces 1922A and/or optional housing 1990 can include one or more peripherals interfaces 1922B. Each of computing system 1920 and optional housing 1990 can also include one or more power systems 1942A and 1942B, one or more controllers 1946 (including one or more haptic controllers 1947), one or more processors 1948A and 1948B (as defined above, including any of the examples provided), and memory 1950A and 1950B, which can all be in electronic communication with each other. For example, the one or more processors 1948A and 1948B can be configured to execute instructions stored in memory 1950A and 1950B, which can cause a controller of one or more of controllers 1946 to cause operations to be performed at one or more peripheral devices connected to peripherals interface 1922A and/or 1922B. In some aspects, each operation described can be powered by electrical power provided by power system 1942A and/or 1942B.

In some aspects, peripherals interface 1922A can include one or more devices configured to be part of computing system 1920, some of which have been defined above and/or described with respect to the wrist-wearable devices shown in FIGS. 15 and 16. For example, peripherals interface 1922A can include one or more sensors 1923A. Some example sensors 1923A include one or more coupling sensors 1924, one or more acoustic sensors 1925, one or more imaging sensors 1926, one or more EMG sensors 1927, one or more capacitive sensors 1928, one or more IMU sensors 1929, and/or any other types of sensors explained above or described with respect to any other aspects discussed herein.

In some aspects, peripherals interfaces 1922A and 1922B can include one or more additional peripheral devices, including one or more NFC devices 1930, one or more GPS devices 1931, one or more LTE devices 1932, one or more Wi-Fi and/or Bluetooth devices 1933, one or more buttons 1934 (e.g., including buttons that are slidable or otherwise adjustable), one or more displays 1935A and 1935B, one or more speakers 1936A and 1936B, one or more microphones 1937, one or more cameras 1938A and 1938B (e.g., including the left camera 1939A and/or a right camera 1939B), one or more haptic devices 1940, and/or any other types of peripheral devices defined above or described with respect to any other aspects discussed herein.

AR systems can include a variety of types of visual feedback mechanisms (e.g., presentation devices). For example, display devices in AR system 1700 and/or VR system 1810 can include one or more liquid-crystal displays (LCDs), light emitting diode (LED) displays, organic LED (OLED) displays, and/or any other suitable types of display screens. Artificial-reality systems can include a single display screen (e.g., configured to be seen by both eyes), and/or can provide separate display screens for each eye, which can allow for additional flexibility for varifocal adjustments and/or for correcting a refractive error associated with a user's vision. Some aspects of AR systems also include optical subsystems having one or more lenses (e.g., conventional concave or convex lenses, Fresnel lenses, or adjustable liquid lenses) through which a user can view a display screen.

For example, respective displays 1935A and 1935B can be coupled to each of the lenses 1706-1 and 1706-2 of AR system 1700. Displays 1935A and 1935B may be coupled to each of lenses 1706-1 and 1706-2, which can act together or independently to present an image or series of images to a user. In some aspects, AR system 1700 includes a single display 1935A or 1935B (e.g., a near-eye display) or more than two displays 1935A and 1935B. In some aspects, a first set of one or more displays 1935A and 1935B can be used to present an augmented-reality environment, and a second set of one or more display devices 1935A and 1935B can be used to present a virtual-reality environment. In some aspects, one or more waveguides are used in conjunction with presenting artificial-reality content to the user of AR system 1700 (e.g., as a means of delivering light from one or more displays 1935A and 1935B to the user's eyes). In some aspects, one or more waveguides are fully or partially integrated into the eyewear device 1702. Additionally, or alternatively to display screens, some artificial-reality systems include one or more projection systems. For example, display devices in AR system 1700 and/or VR system 1810 can include micro-LED projectors that project light (e.g., using a waveguide) into display devices, such as clear combiner lenses that allow ambient light to pass through. The display devices can refract the projected light toward a user's pupil and can enable a user to simultaneously view both artificial-reality content and the real world. Artificial-reality systems can also be configured with any other suitable type or form of image projection system. In some aspects, one or more waveguides are provided additionally or alternatively to the one or more display(s) 1935A and 1935B.

Computing system 1920 and/or optional housing 1990 of AR system 1700 or VR system 1810 can include some or all of the components of a power system 1942A and 1942B. Power systems 1942A and 1942B can include one or more charger inputs 1943, one or more PMICs 1944, and/or one or more batteries 1945A and 1944B.

Memory 1950A and 1950B may include instructions and data, some or all of which may be stored as non-transitory computer-readable storage media within the memories 1950A and 1950B. For example, memory 1950A and 1950B can include one or more operating systems 1951, one or more applications 1952, one or more communication interface applications 1953A and 1953B, one or more graphics applications 1954A and 1954B, one or more AR processing applications 1955A and 1955B, and/or any other types of data defined above or described with respect to any other aspects discussed herein.

Memory 1950A and 1950B also include data 1960A and 1960B, which can be used in conjunction with one or more of the applications discussed above. Data 1960A and 1960B can include profile data 1961, sensor data 1962A and 1962B, media content data 1963A, AR application data 1964A and 1964B, and/or any other types of data defined above or described with respect to any other aspects discussed herein.

In some aspects, controller 1946 of eyewear device 1702 may process information generated by sensors 1923A and/or 1923B on eyewear device 1702 and/or another electronic device within AR system 1700. For example, controller 1946 can process information from acoustic sensors 1725-1 and 1725-2. For each detected sound, controller 1946 can perform a direction of arrival (DOA) estimation to estimate a direction from which the detected sound arrived at eyewear device 1702 of R system 1700. As one or more of acoustic sensors 1925 (e.g., the acoustic sensors 1725-1, 1725-2) detects sounds, controller 1946 can populate an audio data set with the information (e.g., represented in FIG. 10 as sensor data 1962A and 1962B).

In some aspects, a physical electronic connector can convey information between eyewear device 1702 and another electronic device and/or between one or more processors 1748, 1948A, 1948B of AR system 1700 or VR system 1810 and controller 1946. The information can be in the form of optical data, electrical data, wireless data, or any other transmittable data form. Moving the processing of information generated by eyewear device 1702 to an intermediary processing device can reduce weight and heat in the eyewear device, making it more comfortable and safer for a user. In some aspects, an optional wearable accessory device (e.g., an electronic neckband) is coupled to eyewear device 1702 via one or more connectors. The connectors can be wired or wireless connectors and can include electrical and/or non-electrical (e.g., structural) components. In some aspects, eyewear device 1702 and the wearable accessory device can operate independently without any wired or wireless connection between them.

In some situations, pairing external devices, such as an intermediary processing device (e.g., HIPD 1106, 1206, 1306) with eyewear device 1702 (e.g., as part of AR system 1700) enables eyewear device 1702 to achieve a similar form factor of a pair of glasses while still providing sufficient battery and computation power for expanded capabilities. Some, or all, of the battery power, computational resources, and/or additional features of AR system 1700 can be provided by a paired device or shared between a paired device and eyewear device 1702, thus reducing the weight, heat profile, and form factor of eyewear device 1702 overall while allowing eyewear device 1702 to retain its desired functionality. For example, the wearable accessory device can allow components that would otherwise be included on eyewear device 1702 to be included in the wearable accessory device and/or intermediary processing device, thereby shifting a weight load from the user's head and neck to one or more other portions of the user's body. In some aspects, the intermediary processing device has a larger surface area over which to diffuse and disperse heat to the ambient environment. Thus, the intermediary processing device can allow for greater battery and computation capacity than might otherwise have been possible on eyewear device 1702 standing alone. Because weight carried in the wearable accessory device can be less invasive to a user than weight carried in the eyewear device 1702, a user may tolerate wearing a lighter eyewear device and carrying or wearing the paired device for greater lengths of time than the user would tolerate wearing a heavier eyewear device standing alone, thereby enabling an artificial-reality environment to be incorporated more fully into a user's day-to-day activities.

AR systems can include various types of computer vision components and subsystems. For example, AR system 1700 and/or VR system 1810 can include one or more optical sensors such as two-dimensional (2D) or three-dimensional (3D) cameras, time-of-flight depth sensors, structured light transmitters and detectors, single-beam or sweeping laser rangefinders, 3D LiDAR sensors, and/or any other suitable type or form of optical sensor. An AR system can process data from one or more of these sensors to identify a location of a user and/or aspects of the use's real-world physical surroundings, including the locations of real-world objects within the real-world physical surroundings. In some aspects, the methods described herein are used to map the real world, to provide a user with context about real-world surroundings, and/or to generate digital twins (e.g., interactable virtual objects), among a variety of other functions. For example, FIGS. 18A and 18B show VR system 1810 having cameras 1839A to 1839D, which can be used to provide depth information for creating a voxel field and a two-dimensional mesh to provide object information to the user to avoid collisions.

In some aspects, AR system 1700 and/or VR system 1810 can include haptic (tactile) feedback systems, which may be incorporated into headwear, gloves, body suits, handheld controllers, environmental devices (e.g., chairs or floormats), and/or any other type of device or system, such as the wearable devices discussed herein. The haptic feedback systems may provide various types of cutaneous feedback, including vibration, force, traction, shear, texture, and/or temperature. The haptic feedback systems may also provide various types of kinesthetic feedback, such as motion and compliance. The haptic feedback may be implemented using motors, piezoelectric actuators, fluidic systems, and/or a variety of other types of feedback mechanisms. The haptic feedback systems may be implemented independently of other artificial-reality devices, within other artificial-reality devices, and/or in conjunction with other artificial-reality devices.

In some aspects of an artificial reality system, such as AR system 1700 and/or VR system 1810, ambient light (e.g., a live feed of the surrounding environment that a user would normally see) can be passed through a display element of a respective head-wearable device presenting aspects of the AR system. In some aspects, ambient light can be passed through a portion less that is less than all of an AR environment presented within a user's field of view (e.g., a portion of the AR environment co-located with a physical object in the user's real-world environment that is within a designated boundary (e.g., a guardian boundary) configured to be used by the user while they are interacting with the AR environment). For example, a visual user interface element (e.g., a notification user interface element) can be presented at the head-wearable device, and an amount of ambient light (e.g., 15-50% of the ambient light) can be passed through the user interface element such that the user can distinguish at least a portion of the physical environment over which the user interface element is being displayed.

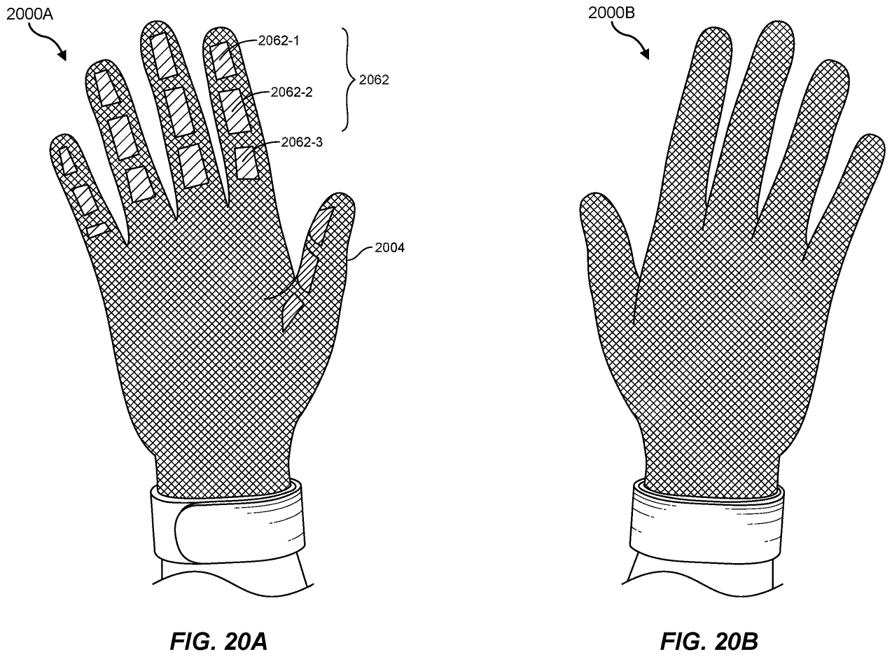

FIGS. 20A and 20B illustrate an example handheld intermediary processing device (HIPD) 2000 in accordance with some aspects. HIPD 2000 is an instance of the intermediary device described herein, such that HIPD 2000 should be understood to have the features described with respect to any intermediary device defined above or otherwise described herein and vice versa. FIG. 20A shows a top view and FIG. 20B shows a side view of the HIPD 2000. HIPD 2000 is configured to communicatively couple with one or more wearable devices (or other electronic devices) associated with a user. For example, HIPD 2000 is configured to communicatively couple with a user's wrist-wearable device 1102, 1202 (or components thereof, such as watch body 1520 and wearable band 1510), AR glasses 1700, and/or VR headset 1350 and 1800. HIPD 2000 can be configured to be held by a user (e.g., as a handheld controller), carried on the user's person (e.g., in their pocket, in their bag, etc.), placed in proximity of the user (e.g., placed on their desk while seated at their desk, on a charging dock, etc.), and/or placed at or within a predetermined distance from a wearable device or other electronic device (e.g., where, in some aspects, the predetermined distance is the maximum distance (e.g., 10 meters) at which HIPD 2000 can successfully be communicatively coupled with an electronic device, such as a wearable device).

HIPD 2000 can perform various functions independently and/or in conjunction with one or more wearable devices (e.g., wrist-wearable device 1102, AR glasses 1700, VR system 1810, etc.). HIPD 2000 can be configured to increase and/or improve the functionality of communicatively coupled devices, such as the wearable devices. HIPD 2000 can be configured to perform one or more functions or operations associated with interacting with user interfaces and applications of communicatively coupled devices, interacting with an AR environment, interacting with VR environment, and/or operating as a human-machine interface controller, as well as functions and/or operations described above with reference to FIGS. 11-13B. Additionally, as will be described in more detail below, functionality and/or operations of HIPD 2000 can include, without limitation, task offloading and/or handoffs; thermals offloading and/or handoffs; six degrees of freedom (6 DoF) raycasting and/or gaming (e.g., using imaging devices or cameras 2014A, 2014B, which can be used for simultaneous localization and mapping (SLAM) and/or with other image processing techniques), portable charging, messaging, image capturing via one or more imaging devices or cameras 2022A and 2022B, sensing user input (e.g., sensing a touch on a touch input surface 2002), wireless communications and/or interlining (e.g., cellular, near field, Wi-Fi, personal area network, etc.), location determination, financial transactions, providing haptic feedback, alarms, notifications, biometric authentication, health monitoring, sleep monitoring, etc. The above-described example functions can be executed independently in HIPD 2000 and/or in communication between HIPD 2000 and another wearable device described herein. In some aspects, functions can be executed on HIPD 2000 in conjunction with an AR environment. As the skilled artisan will appreciate upon reading the descriptions provided herein that HIPD 2000 can be used with any type of suitable AR environment.

While HIPD 2000 is communicatively coupled with a wearable device and/or other electronic device, HIPD 2000 is configured to perform one or more operations initiated at the wearable device and/or the other electronic device. In particular, one or more operations of the wearable device and/or the other electronic device can be offloaded to HIPD 2000 to be performed. HIPD 2000 performs the one or more operations of the wearable device and/or the other electronic device and provides to data corresponded to the completed operations to the wearable device and/or the other electronic device. For example, a user can initiate a video stream using AR glasses 1700 and back-end tasks associated with performing the video stream (e.g., video rendering) can be offloaded to HIPD 2000, which HIPD 2000 performs and provides corresponding data to AR glasses 1700 to perform remaining front-end tasks associated with the video stream (e.g., presenting the rendered video data via a display of AR glasses 1700). In this way, HIPD 2000, which has more computational resources and greater thermal headroom than a wearable device, can perform computationally intensive tasks for the wearable device, thereby improving performance of an operation performed by the wearable device.

HIPD 2000 includes a multi-touch input surface 2002 on a first side (e.g., a front surface) that is configured to detect one or more user inputs. In particular, multi-touch input surface 2002 can detect single tap inputs, multi-tap inputs, swipe gestures and/or inputs, force-based and/or pressure-based touch inputs, held taps, and the like. Multi-touch input surface 2002 is configured to detect capacitive touch inputs and/or force (and/or pressure) touch inputs. Multi-touch input surface 2002 includes a first touch-input surface 2004 defined by a surface depression and a second touch-input surface 2006 defined by a substantially planar portion. First touch-input surface 2004 can be disposed adjacent to second touch-input surface 2006. In some aspects, first touch-input surface 2004 and second touch-input surface 2006 can be different dimensions and/or shapes. For example, first touch-input surface 2004 can be substantially circular and second touch-input surface 2006 can be substantially rectangular. In some aspects, the surface depression of multi-touch input surface 2002 is configured to guide user handling of HIPD 2000. In particular, the surface depression can be configured such that the user holds HIPD 2000 upright when held in a single hand (e.g., such that the using imaging devices or cameras 2014A and 2014B are pointed toward a ceiling or the sky). Additionally, the surface depression is configured such that the user's thumb rests within first touch-input surface 2004.

In some aspects, the different touch-input surfaces include a plurality of touch-input zones. For example, second touch-input surface 2006 includes at least a second touch-input zone 2008 within a first touch-input zone 2007 and a third touch-input zone 2010 within second touch-input zone 2008. In some aspects, one or more of touch-input zones 2008 and 2010 are optional and/or user defined (e.g., a user can specific a touch-input zone based on their preferences). In some aspects, each touch-input surface 2004 and 2006 and/or touch-input zone 2008 and 2010 are associated with a predetermined set of commands. For example, a user input detected within first touch-input zone 2008 may cause HIPD 2000 to perform a first command and a user input detected within second touch-input surface 2006 may cause HIPD 2000 to perform a second command, distinct from the first. In some aspects, different touch-input surfaces and/or touch-input zones are configured to detect one or more types of user inputs. The different touch-input surfaces and/or touch-input zones can be configured to detect the same or distinct types of user inputs. For example, first touch-input zone 2008 can be configured to detect force touch inputs (e.g., a magnitude at which the user presses down) and capacitive touch inputs, and second touch-input zone 2010 can be configured to detect capacitive touch inputs.

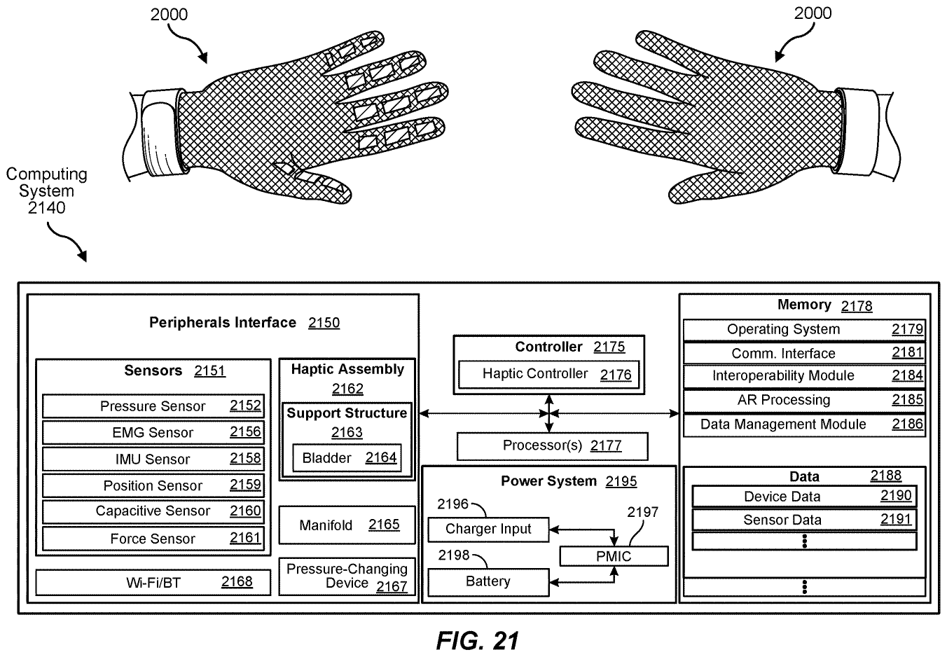

As shown in FIG. 21, HIPD 2000 includes one or more sensors 2151 for sensing data used in the performance of one or more operations and/or functions. For example, HIPD 2000 can include an IMU sensor that is used in conjunction with cameras 2014A, 2014B (FIGS. 20A-20B) for 3-dimensional object manipulation (e.g., enlarging, moving, destroying, etc., an object) in an AR or VR environment. Non-limiting examples of sensors 2151 included in HIPD 2000 include a light sensor, a magnetometer, a depth sensor, a pressure sensor, and a force sensor.

HIPD 2000 can include one or more light indicators 2012 to provide one or more notifications to the user. In some aspects, light indicators 2012 are LEDs or other types of illumination devices. Light indicators 2012 can operate as a privacy light to notify the user and/or others near the user that an imaging device and/or microphone are active. In some aspects, a light indicator is positioned adjacent to one or more touch-input surfaces. For example, a light indicator can be positioned around first touch-input surface 2004. Light indicators 2012 can be illuminated in different colors and/or patterns to provide the user with one or more notifications and/or information about the device. For example, a light indicator positioned around first touch-input surface 2004 may flash when the user receives a notification (e.g., a message), change red when HIPD 2000 is out of power, operate as a progress bar (e.g., a light ring that is closed when a task is completed (e.g., 0% to 100%)), operate as a volume indicator, etc.

In some aspects, HIPD 2000 includes one or more additional sensors on another surface. For example, as shown FIG. 20A, HIPD 2000 includes a set of one or more sensors (e.g., sensor set 2020) on an edge of HIPD 2000. Sensor set 2020, when positioned on an edge of the of HIPD 2000, can be pe positioned at a predetermined tilt angle (e.g., 26 degrees), which allows sensor set 2020 to be angled toward the user when placed on a desk or other flat surface. Alternatively, in some aspects, sensor set 2020 is positioned on a surface opposite the multi-touch input surface 2002 (e.g., a back surface). The one or more sensors of sensor set 2020 are discussed in further detail below.

The side view of the of HIPD 2000 in FIG. 20B shows sensor set 2020 and camera 2014B. Sensor set 2020 can include one or more cameras 2022A and 2022B, a depth projector 2024, an ambient light sensor 2028, and a depth receiver 2030. In some aspects, sensor set 2020 includes a light indicator 2026. Light indicator 2026 can operate as a privacy indicator to let the user and/or those around them know that a camera and/or microphone is active. Sensor set 2020 is configured to capture a user's facial expression such that the user can puppet a custom avatar (e.g., showing emotions, such as smiles, laughter, etc., on the avatar or a digital representation of the user). Sensor set 2020 can be configured as a side stereo RGB system, a rear indirect Time-of-Flight (iToF) system, or a rear stereo RGB system. As the skilled artisan will appreciate upon reading the descriptions provided herein, HIPD 2000 described herein can use different sensor set 2020 configurations and/or sensor set 2020 placement.

Turning to FIG. 21, in some aspects, a computing system 2140 of HIPD 2000 can include one or more haptic devices 2171 (e.g., a vibratory haptic actuator) that are configured to provide haptic feedback (e.g., kinesthetic sensation). Sensors 2151 and/or the haptic devices 2171 can be configured to operate in conjunction with multiple applications and/or communicatively coupled devices including, without limitation, a wearable devices, health monitoring applications, social media applications, game applications, and artificial reality applications (e.g., the applications associated with artificial reality).

In some aspects, HIPD 2000 is configured to operate without a display. However, optionally, computing system 2140 of the HIPD 2000 can include a display 2168. HIPD 2000 can also include one or more optional peripheral buttons 2167. For example, peripheral buttons 2167 can be used to turn on or turn off HIPD 2000. Further, HIPD 2000 housing can be formed of polymers and/or elastomers. In other words, HIPD 2000 may be designed such that it would not easily slide off a surface. In some aspects, HIPD 2000 includes one or magnets to couple HIPD 2000 to another surface. This allows the user to mount HIPD 2000 to different surfaces and provide the user with greater flexibility in use of HIPD 2000.

As described above, HIPD 2000 can distribute and/or provide instructions for performing the one or more tasks at HIPD 2000 and/or a communicatively coupled device. For example, HIPD 2000 can identify one or more back-end tasks to be performed by HIPD 2000 and one or more front-end tasks to be performed by a communicatively coupled device. While HIPD 2000 is configured to offload and/or handoff tasks of a communicatively coupled device, HIPD 2000 can perform both back-end and front-end tasks (e.g., via one or more processors, such as CPU 2177). HIPD 2000 can, without limitation, can be used to perform augmented calling (e.g., receiving and/or sending 3D or 2.5D live volumetric calls, live digital human representation calls, and/or avatar calls), discreet messaging, 6 DoF portrait/landscape gaming, AR/VR object manipulation, AR/VR content display (e.g., presenting content via a virtual display), and/or other AR/VR interactions. HIPD 2000 can perform the above operations alone or in conjunction with a wearable device (or other communicatively coupled electronic device).

FIG. 21 shows a block diagram of a computing system 2140 of HIPD 2000 in accordance with some aspects. HIPD 2000, described in detail above, can include one or more components shown in HIPD computing system 2140. HIPD 2000 will be understood to include the components shown and described below for HIPD computing system 2140. In some aspects, all, or a substantial portion of the components of HIPD computing system 2140 are included in a single integrated circuit. Alternatively, in some aspects, components of HIPD computing system 2140 are included in a plurality of integrated circuits that are communicatively coupled.

HIPD computing system 2140 can include a processor (e.g., a CPU 2177, a GPU, and/or a CPU with integrated graphics), a controller 2175, a peripherals interface 2150 that includes one or more sensors 2151 and other peripheral devices, a power source (e.g., a power system 2195), and memory (e.g., a memory 2178) that includes an operating system (e.g., an operating system 2179), data (e.g., data 2188), one or more applications (e.g., applications 2180), and one or more modules (e.g., a communications interface module 2181, a graphics module 2182, a task and processing management module 2183, an interoperability module 2184, an AR processing module 2185, a data management module 2186, etc.). HIPD computing system 2140 further includes a power system 2195 that includes a charger input and output 2196, a PMIC 2197, and a battery 2198, all of which are defined above.

In some aspects, peripherals interface 2150 can include one or more sensors 2151. Sensors 2151 can include analogous sensors to those described above in reference to FIG. 15. For example, sensors 2151 can include imaging sensors 2154, (optional) EMG sensors 2156, IMU sensors 2158, and capacitive sensors 2160. In some aspects, sensors 2151 can include one or more pressure sensors 2152 for sensing pressure data, an altimeter 2153 for sensing an altitude of the HIPD 2000, a magnetometer 2155 for sensing a magnetic field, a depth sensor 2157 (or a time-of flight sensor) for determining a difference between the camera and the subject of an image, a position sensor 2159 (e.g., a flexible position sensor) for sensing a relative displacement or position change of a portion of the HIPD 2000, a force sensor 2161 for sensing a force applied to a portion of the HIPD 2000, and a light sensor 2162 (e.g., an ambient light sensor) for detecting an amount of lighting. Sensors 2151 can include one or more sensors not shown in FIG. 21.

Analogous to the peripherals described above in reference to FIG. 15, peripherals interface 2150 can also include an NFC component 2163, a GPS component 2164, an LTE component 2165, a Wi-Fi and/or Bluetooth communication component 2166, a speaker 2169, a haptic device 2171, and a microphone 2173. As noted above, HIPD 2000 can optionally include a display 2168 and/or one or more peripheral buttons 2167. Peripherals interface 2150 can further include one or more cameras 2170, touch surfaces 2172, and/or one or more light emitters 2174. Multi-touch input surface 2002 described above in reference to FIGS. 20A and 20B is an example of touch surface 2172. Light emitters 2174 can be one or more LEDs, lasers, etc. and can be used to project or present information to a user. For example, light emitters 2174 can include light indicators 2012 and 2026 described above in reference to FIGS. 20A and 20B. Cameras 2170 (e.g., cameras 2014A, 2014B, 2022A, and 2022B described above in reference to FIGS. 20A and 20B) can include one or more wide angle cameras, fish-eye cameras, spherical cameras, compound eye cameras (e.g., stereo and multi cameras), depth cameras, RGB cameras, ToF cameras, RGB-D cameras (depth and ToF cameras), and/or other suitable cameras. Cameras 2170 can be used for SLAM, 6 DoF ray casting, gaming, object manipulation and/or other rendering, facial recognition and facial expression recognition, etc.

Similar to watch body computing system 1660 and watch band computing system 1630 described above in reference to FIG. 16, HIPD computing system 2140 can include one or more haptic controllers 2176 and associated componentry (e.g., haptic devices 2171) for providing haptic events at HIPD 2000.

Memory 2178 can include high-speed random-access memory and/or non-volatile memory, such as one or more magnetic disk storage devices, flash memory devices, or other non-volatile solid-state memory devices. Access to memory 2178 by other components of HIPD 2000, such as the one or more processors and peripherals interface 2150, can be controlled by a memory controller of controllers 2175.

In some aspects, software components stored in memory 2178 include one or more operating systems 2179, one or more applications 2180, one or more communication interface modules 2181, one or more graphics modules 2182, and/or one or more data management modules 2186, which are analogous to the software components described above in reference to FIG. 15.

In some aspects, software components stored in memory 2178 include a task and processing management module 2183 for identifying one or more front-end and back-end tasks associated with an operation performed by the user, performing one or more front-end and/or back-end tasks, and/or providing instructions to one or more communicatively coupled devices that cause performance of the one or more front-end and/or back-end tasks. In some aspects, task and processing management module 2183 uses data 2188 (e.g., device data 2190) to distribute the one or more front-end and/or back-end tasks based on communicatively coupled devices'computing resources, available power, thermal headroom, ongoing operations, and/or other factors. For example, task and processing management module 2183 can cause the performance of one or more back-end tasks (of an operation performed at communicatively coupled AR system 1700) at HIPD 2000 in accordance with a determination that the operation is utilizing a predetermined amount (e.g., at least 70%) of computing resources available at AR system 1700.

In some aspects, software components stored in memory 2178 include an interoperability module 2184 for exchanging and utilizing information received and/or provided to distinct communicatively coupled devices. Interoperability module 2184 allows for different systems, devices, and/or applications to connect and communicate in a coordinated way without user input. In some aspects, software components stored in memory 2178 include an AR processing module 2185 that is configured to process signals based at least on sensor data for use in an AR and/or VR environment. For example, AR processing module 2185 can be used for 3D object manipulation, gesture recognition, facial and facial expression recognition, etc.

Memory 2178 can also include data 2188. In some aspects, data 2188 can include profile data 2189, device data 2190 (including device data of one or more devices communicatively coupled with HIPD 2000, such as device type, hardware, software, configurations, etc.), sensor data 2191, media content data 2192, and application data 2193.

It should be appreciated that HIPD computing system 2140 is an example of a computing system within HIPD 2000, and that HIPD 2000 can have more or fewer components than shown in HIPD computing system 2140, combine two or more components, and/or have a different configuration and/or arrangement of the components. The various components shown HIPD computing system 2140 are implemented in hardware, software, firmware, or a combination thereof, including one or more signal processing and/or application-specific integrated circuits.

The techniques described above in FIGS. 20A, 20B, and 21 can be used with any device used as a human-machine interface controller. In some aspects, an HIPD 2000 can be used in conjunction with one or more wearable device such as a head-wearable device (e.g., AR system 1700 and VR system 1810) and/or a wrist-wearable device 1500 (or components thereof).

In some aspects, the artificial reality devices and/or accessory devices disclosed herein may include haptic interfaces with transducers that provide haptic feedback and/or that collect haptic information about a user's interaction with an environment. The artificial-reality systems disclosed herein may include various types of haptic interfaces that detect or convey various types of haptic information, including tactile feedback (e.g., feedback that a user detects via nerves in the skin, which may also be referred to as cutaneous feedback) and/or kinesthetic feedback (e.g., feedback that a user detects via receptors located in muscles, joints, and/or tendons). In some examples, cutaneous feedback may include vibration, force, traction, texture, and/or temperature. Similarly, kinesthetic feedback, may include motion and compliance. Cutaneous and/or kinesthetic feedback may be provided using motors, piezoelectric actuators, fluidic systems, and/or a variety of other types of feedback mechanisms. Furthermore, haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For instance, artificial-reality systems may assist or extend a user's perception, memory, or cognition within a particular environment. Some systems may enhance a user's interactions with other people in the real world or may enable more immersive interactions with other people in a virtual world. Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The haptics assemblies disclosed herein may enable or enhance a user's artificial-reality experience in one or more of these contexts and environments and/or in other contexts and environments.

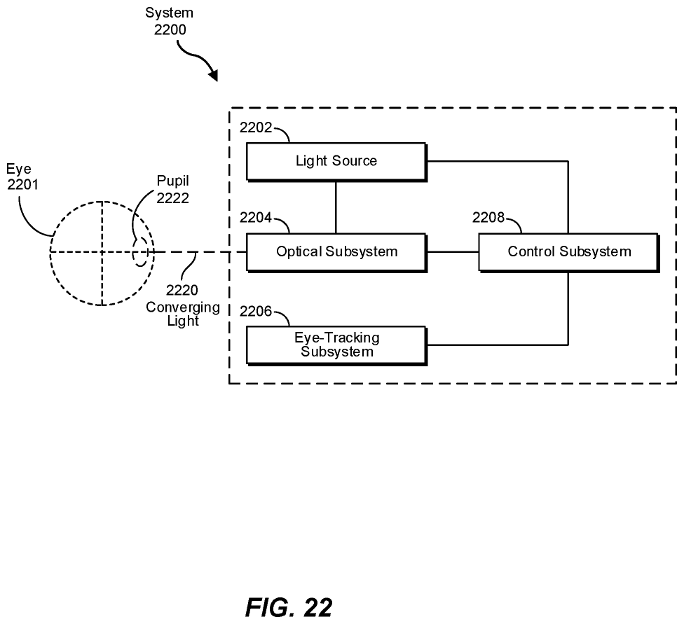

FIGS. 22A and 22B show example haptic feedback systems (e.g., hand-wearable devices) for providing feedback to a user regarding the user's interactions with a computing system (e.g., an artificial-reality environment presented by the AR system 1700 or the VR system 1810). In some aspects, a computing system (e.g., the AR systems 1300 and/or 1400) may also provide feedback to one or more users based on an action that was performed within the computing system and/or an interaction provided by the AR system (e.g., which may be based on instructions that are executed in conjunction with performing operations of an application of the computing system). Such feedback may include visual and/or audio feedback and may also include haptic feedback provided by a haptic assembly, such as one or more haptic assemblies 2262 of haptic device 2200 (e.g., haptic assemblies 2262-1, 2262-2, 2262-3, etc.). For example, the haptic feedback may prevent (or, at a minimum, hinder/resist movement of) one or more fingers of a user from bending past a certain point to simulate the sensation of touching a solid coffee mug. In actuating such haptic effects, haptic device 2200 can change (either directly or indirectly) a pressurized state of one or more of haptic assemblies 2262.

Vibrotactile system 2200 may optionally include other subsystems and components, such as touch-sensitive pads, pressure sensors, motion sensors, position sensors, lighting elements, and/or user interface elements (e.g., an on/off button, a vibration control element, etc.). During use, haptic assemblies 2262 may be configured to be activated for a variety of different reasons, such as in response to the user's interaction with user interface elements, a signal from the motion or position sensors, a signal from the touch-sensitive pads, a signal from the pressure sensors, a signal from the other device or system, etc.

In FIGS. 22A and 22B, each of haptic assemblies 2262 may include a mechanism that, at a minimum, provides resistance when the respective haptic assembly 2262 is transitioned from a first pressurized state (e.g., atmospheric pressure or deflated) to a second pressurized state (e.g., inflated to a threshold pressure). Structures of haptic assemblies 2262 can be integrated into various devices configured to be in contact or proximity to a user's skin, including, but not limited to devices such as glove worn devices, body worn clothing device, headset devices.

As noted above, haptic assemblies 2262 described herein can be configured to transition between a first pressurized state and a second pressurized state to provide haptic feedback to the user. Due to the ever-changing nature of artificial-reality, haptic assemblies 2262 may be required to transition between the two states hundreds, or perhaps thousands of times, during a single use. Thus, haptic assemblies 2262 described herein are durable and designed to quickly transition from state to state. To provide some context, in the first pressurized state, haptic assemblies 2262 do not impede free movement of a portion of the wearer's body. For example, one or more haptic assemblies 2262 incorporated into a glove are made from flexible materials that do not impede free movement of the wearer's hand and fingers (e.g., an electrostatic-zipping actuator). Haptic assemblies 2262 may be configured to conform to a shape of the portion of the wearer's body when in the first pressurized state. However, once in the second pressurized state, haptic assemblies 2262 can be configured to restrict and/or impede free movement of the portion of the wearer's body (e.g., appendages of the user's hand). For example, the respective haptic assembly 2262 (or multiple respective haptic assemblies) can restrict movement of a wearer's finger (e.g., prevent the finger from curling or extending) when haptic assembly 2262 is in the second pressurized state. Moreover, once in the second pressurized state, haptic assemblies 2262 may take different shapes, with some haptic assemblies 2262 configured to take a planar, rigid shape (e.g., flat and rigid), while some other haptic assemblies 2262 are configured to curve or bend, at least partially.

As a non-limiting example, haptic device 2200 includes a plurality of haptic devices (e.g., a pair of haptic gloves, a haptics component of a wrist-wearable device (e.g., any of the wrist-wearable devices described with respect to FIGS. 11-15), etc.), each of which can include a garment component (e.g., a garment 2204) and one or more haptic assemblies coupled (e.g., physically coupled) to the garment component. For example, each of the haptic assemblies 2262-1, 2262-2, 2262-3, . . . 2262-N are physically coupled to the garment 2204 and are configured to contact respective phalanges of a user's thumb and fingers. As explained above, haptic assemblies 2262 are configured to provide haptic simulations to a wearer of device 2200. Garment 2204 of each device 2200 can be one of various articles of clothing (e.g., gloves, socks, shirts, pants, etc.). Thus, a user may wear multiple haptic devices 2200 that are each configured to provide haptic stimulations to respective parts of the body where haptic devices 2200 are being worn.

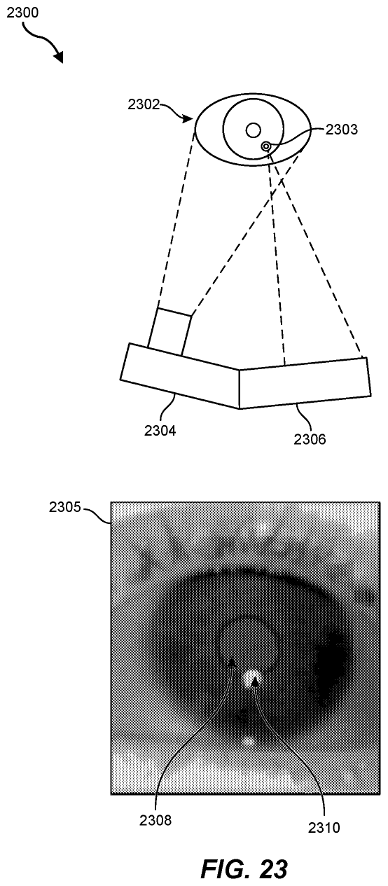

FIG. 23 shows block diagrams of a computing system 2340 of haptic device 2200, in accordance with some aspects. Computing system 2340 can include one or more peripherals interfaces 2350, one or more power systems 2395, one or more controllers 2375 (including one or more haptic controllers 2376), one or more processors 2377 (as defined above, including any of the examples provided), and memory 2378, which can all be in electronic communication with each other. For example, one or more processors 2377 can be configured to execute instructions stored in the memory 2378, which can cause a controller of the one or more controllers 2375 to cause operations to be performed at one or more peripheral devices of peripherals interface 2350. In some aspects, each operation described can occur based on electrical power provided by the power system 2395. The power system 2395 can include a charger input 2396, a PMIC 2397, and a battery 2398.

In some aspects, peripherals interface 2350 can include one or more devices configured to be part of computing system 2340, many of which have been defined above and/or described with respect to wrist-wearable devices shown in FIGS. 15 and 16. For example, peripherals interface 2350 can include one or more sensors 2351. Some example sensors include: one or more pressure sensors 2352, one or more EMG sensors 2356, one or more IMU sensors 2358, one or more position sensors 2359, one or more capacitive sensors 2360, one or more force sensors 2361; and/or any other types of sensors defined above or described with respect to any other aspects discussed herein.

In some aspects, the peripherals interface can include one or more additional peripheral devices, including one or more Wi-Fi and/or Bluetooth devices 2368; one or more haptic assemblies 2362; one or more support structures 2363 (which can include one or more bladders 2364; one or more manifolds 2365; one or more pressure-changing devices 2367; and/or any other types of peripheral devices defined above or described with respect to any other aspects discussed herein.

In some aspects, each haptic assembly 2362 includes a support structure 2363 and at least one bladder 2364. Bladder 2364 (e.g., a membrane) may be a sealed, inflatable pocket made from a durable and puncture-resistant material, such as thermoplastic polyurethane (TPU), a flexible polymer, or the like. Bladder 2364 contains a medium (e.g., a fluid such as air, inert gas, or even a liquid) that can be added to or removed from bladder 2364 to change a pressure (e.g., fluid pressure) inside the bladder 2364. Support structure 2363 is made from a material that is stronger and stiffer than the material of bladder 2364. A respective support structure 2363 coupled to a respective bladder 2364 is configured to reinforce the respective bladder 2364 as the respective bladder 2364 changes shape and size due to changes in pressure (e.g., fluid pressure) inside the bladder.

The system 2340 also includes a haptic controller 2376 and a pressure-changing device 2367. In some aspects, haptic controller 2376 is part of the computer system 2340 (e.g., in electronic communication with one or more processors 2377 of the computer system 2340). Haptic controller 2376 is configured to control operation of pressure-changing device 2367, and in turn operation of haptic device 2200. For example, haptic controller 2376 sends one or more signals to pressure-changing device 2367 to activate pressure-changing device 2367 (e.g., turn it on and off). The one or more signals may specify a desired pressure (e.g., pounds-per-square inch) to be output by pressure-changing device 2367. Generation of the one or more signals, and in turn the pressure output by pressure-changing device 2367, may be based on information collected by sensors 2351. For example, the one or more signals may cause pressure-changing device 2367 to increase the pressure (e.g., fluid pressure) inside a first haptic assembly 2362 at a first time, based on the information collected by sensors 2351 (e.g., the user makes contact with an artificial coffee mug or other artificial object). Then, the controller may send one or more additional signals to pressure-changing device 2367 that cause pressure-changing device 2367 to further increase the pressure inside first haptic assembly 2362 at a second time after the first time, based on additional information collected by sensors 2351. Further, the one or more signals may cause pressure-changing device 2367 to inflate one or more bladders 2364 in a first device 2200A, while one or more bladders 2364 in a second device 2200B remain unchanged. Additionally, the one or more signals may cause pressure-changing device 2367 to inflate one or more bladders 2364 in a first device 2200A to a first pressure and inflate one or more other bladders 2364 in first device 2200A to a second pressure different from the first pressure. Depending on number of devices 2200 serviced by pressure-changing device 2367, and the number of bladders therein, many different inflation configurations can be achieved through the one or more signals and the examples above are not meant to be limiting.

The system 2340 may include an optional manifold 2365 between pressure-changing device 2367 and haptic devices 2200. Manifold 2365 may include one or more valves (not shown) that pneumatically couple each of haptic assemblies 2362 with pressure-changing device 2367 via tubing. In some aspects, manifold 2365 is in communication with controller 2375, and controller 2375 controls the one or more valves of manifold 2365 (e.g., the controller generates one or more control signals). Manifold 2365 is configured to switchably couple pressure-changing device 2367 with one or more haptic assemblies 2362 of the same or different haptic devices 2200 based on one or more control signals from controller 2375. In some aspects, instead of using manifold 2365 to pneumatically couple pressure-changing device 2367 with haptic assemblies 2362, system 2340 may include multiple pressure-changing devices 2367, where each pressure-changing device 2367 is pneumatically coupled directly with a single haptic assembly 2362 or multiple haptic assemblies 2362. In some aspects, pressure-changing device 2367 and optional manifold 2365 can be configured as part of one or more of the haptic devices 2200 while, in other aspects, pressure-changing device 2367 and optional manifold 2365 can be configured as external to haptic device 2200. A single pressure-changing device 2367 may be shared by multiple haptic devices 2200.

In some aspects, pressure-changing device 2367 is a pneumatic device, hydraulic device, a pneudraulic device, or some other device capable of adding and removing a medium (e.g., fluid, liquid, gas) from the one or more haptic assemblies 2362.

The devices shown in FIGS. 22A-23 may be coupled via a wired connection (e.g., via busing). Alternatively, one or more of the devices shown in FIGS. 22A-23 may be wirelessly connected (e.g., via short-range communication signals).

Memory 2378 includes instructions and data, some or all of which may be stored as non-transitory computer-readable storage media within memory 2378. For example, memory 2378 can include one or more operating systems 2379; one or more communication interface applications 2381; one or more interoperability modules 2384; one or more AR processing applications 2385; one or more data management modules 2386; and/or any other types of applications or modules defined above or described with respect to any other aspects discussed herein.

Memory 2378 also includes data 2388 which can be used in conjunction with one or more of the applications discussed above. Data 2388 can include: device data 2390; sensor data 2391; and/or any other types of data defined above or described with respect to any other aspects discussed herein.

In some examples, the augmented reality systems described herein may also include a microphone array with a plurality of acoustic transducers. Acoustic transducers may represent transducers that detect air pressure variations induced by sound waves. Each acoustic transducer may be configured to detect sound and convert the detected sound into an electronic format (e.g., an analog or digital format). A microphone array may include, for example, ten acoustic transducers that may be designed to be placed inside a corresponding ear of the user, acoustic transducers that may be positioned at various locations on an HMD frame a watch band, etc.

In some aspects, one or more of acoustic transducers may be used as output transducers (e.g., speakers). For example, the artificial reality systems described herein may include acoustic transducers that are earbuds or any other suitable type of headphone or speaker.

The configuration of acoustic transducers of a microphone array may vary and may include any suitable number of transducers. In some aspects, using higher numbers of acoustic transducers may increase the amount of audio information collected and/or the sensitivity and accuracy of the audio information. In contrast, using a lower number of acoustic transducers may decrease the computing power required by an associated controller to process the collected audio information. In addition, the position of each acoustic transducer of the microphone array may vary. For example, the position of an acoustic transducer may include a defined position on the user, a defined coordinate on a frame of an HMD, an orientation associated with each acoustic transducer, or some combination thereof.

Acoustic transducers and may be positioned on different parts of the user's ear, such as behind the pinna, behind the tragus, and/or within the auricle or fossa. Or there may be additional acoustic transducers on or surrounding the ear in addition to acoustic transducers inside the ear canal. Having an acoustic transducer positioned next to an ear canal of a user may enable the microphone array to collect information on how sounds arrive at the ear canal. By positioning at least two of acoustic transducers on either side of a user's head (e.g., as binaural microphones), an artificial-reality device may simulate binaural hearing and capture a 3D stereo sound field around about a user's head. In some aspects, acoustic transducers may be connected to artificial reality systems via a wired connection, and in other aspects acoustic transducers may be connected to artificial-reality systems via a wireless connection (e.g., a BLUETOOTH connection).

Acoustic transducers may be positioned on HMDs frames in a variety of different ways, including along the length of the temples, across the bridge, above or below display devices, or some combination thereof. Acoustic transducers may also be oriented such that the microphone array is able to detect sounds in a wide range of directions surrounding the user wearing the augmented-reality system. In some aspects, an optimization process may be performed during manufacturing of augmented-reality system to determine relative positioning of each acoustic transducer in the microphone array.

The artificial-reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some aspects, a single transducer may be used for both audio input and audio output.

Some augmented-reality systems may map a user's and/or device's environment using techniques referred to as “simultaneous location and mapping” (SLAM). SLAM mapping and location identifying techniques may involve a variety of hardware and software tools that can create or update a map of an environment while simultaneously keeping track of a user's location within the mapped environment. SLAM may use many different types of sensors to create a map and determine a user's position within the map.

SLAM techniques may, for example, implement optical sensors to determine a user's location. Radios including WiFi, BLUETOOTH, global positioning system (GPS), cellular or other communication devices may be also used to determine a user's location relative to a radio transceiver or group of transceivers (e.g., a WiFi router or group of GPS satellites). Acoustic sensors such as microphone arrays or 2D or 3D sonar sensors may also be used to determine a user's location within an environment. Augmented-reality and virtual-reality devices may incorporate any or all of these types of sensors to perform SLAM operations such as creating and continually updating maps of the user's current environment. In at least some of the aspects described herein, SLAM data generated by these sensors may be referred to as “environmental data” and may indicate a user's current environment. This data may be stored in a local or remote data store (e.g., a cloud data store) and may be provided to a user's AR/VR device on demand.

When the user is wearing an augmented-reality headset or virtual-reality headset in a given environment, the user may be interacting with other users or other electronic devices that serve as audio sources. In some cases, it may be desirable to determine where the audio sources are located relative to the user and then present the audio sources to the user as if they were coming from the location of the audio source. The process of determining where the audio sources are located relative to the user may be referred to as “localization,” and the process of rendering playback of the audio source signal to appear as if it is coming from a specific direction may be referred to as “spatialization.”

Localizing an audio source may be performed in a variety of different ways. In some cases, an augmented-reality or virtual-reality headset may initiate a DOA analysis to determine the location of a sound source. The DOA analysis may include analyzing the intensity, spectra, and/or arrival time of each sound at the artificial-reality device to determine the direction from which the sounds originated. The DOA analysis may include any suitable algorithm for analyzing the surrounding acoustic environment in which the artificial reality device is located.

For example, the DOA analysis may be designed to receive input signals from a microphone and apply digital signal processing algorithms to the input signals to estimate the direction of arrival. These algorithms may include, for example, delay and sum algorithms where the input signal is sampled, and the resulting weighted and delayed versions of the sampled signal are averaged together to determine a direction of arrival. A least mean squared (LMS) algorithm may also be implemented to create an adaptive filter. This adaptive filter may then be used to identify differences in signal intensity, for example, or differences in time of arrival. These differences may then be used to estimate the direction of arrival. In another aspect, the DOA may be determined by converting the input signals into the frequency domain and selecting specific bins within the time-frequency (TF) domain to process. Each selected TF bin may be processed to determine whether that bin includes a portion of the audio spectrum with a direct-path audio signal. Those bins having a portion of the direct-path signal may then be analyzed to identify the angle at which a microphone array received the direct-path audio signal. The determined angle may then be used to identify the direction of arrival for the received input signal. Other algorithms not listed above may also be used alone or in combination with the above algorithms to determine DOA.

In some aspects, different users may perceive the source of a sound as coming from slightly different locations. This may be the result of each user having a unique head-related transfer function (HRTF), which may be dictated by a user's anatomy including ear canal length and the positioning of the ear drum. The artificial-reality device may provide an alignment and orientation guide, which the user may follow to customize the sound signal presented to the user based on their unique HRTF. In some aspects, an artificial reality device may implement one or more microphones to listen to sounds within the user's environment. The augmented reality or virtual reality headset may use a variety of different array transfer functions (e.g., any of the DOA algorithms identified above) to estimate the direction of arrival for the sounds. Once the direction of arrival has been determined, the artificial-reality device may play back sounds to the user according to the user's unique HRTF. Accordingly, the DOA estimation generated using the array transfer function (ATF) may be used to determine the direction from which the sounds are to be played from. The playback sounds may be further refined based on how that specific user hears sounds according to the HRTF.

In addition to or as an alternative to performing a DOA estimation, an artificial-reality device may perform localization based on information received from other types of sensors. These sensors may include cameras, IR sensors, heat sensors, motion sensors, GPS receivers, or in some cases, sensors that detect a user's eye movements. For example, as noted above, an artificial-reality device may include an eye tracker or gaze detector that determines where the user is looking. Often, the user's eyes will look at the source of the sound, if only briefly. Such clues provided by the user's eyes may further aid in determining the location of a sound source. Other sensors such as cameras, heat sensors, and IR sensors may also indicate the location of a user, the location of an electronic device, or the location of another sound source. Any or all of the above methods may be used individually or in combination to determine the location of a sound source and may further be used to update the location of a sound source over time.

Some aspects may implement the determined DOA to generate a more customized output audio signal for the user. For instance, an “acoustic transfer function” may characterize or define how a sound is received from a given location. More specifically, an acoustic transfer function may define the relationship between parameters of a sound at its source location and the parameters by which the sound signal is detected (e.g., detected by a microphone array or detected by a user's ear). An artificial-reality device may include one or more acoustic sensors that detect sounds within range of the device. A controller of the artificial-reality device may estimate a DOA for the detected sounds (using, e.g., any of the methods identified above) and, based on the parameters of the detected sounds, may generate an acoustic transfer function that is specific to the location of the device. This customized acoustic transfer function may thus be used to generate a spatialized output audio signal where the sound is perceived as coming from a specific location.

Indeed, once the location of the sound source or sources is known, the artificial-reality device may re-render (i.e., spatialize) the sound signals to sound as if coming from the direction of that sound source. The artificial-reality device may apply filters or other digital signal processing that alter the intensity, spectra, or arrival time of the sound signal. The digital signal processing may be applied in such a way that the sound signal is perceived as originating from the determined location. The artificial-reality device may amplify or subdue certain frequencies or change the time that the signal arrives at each ear. In some cases, the artificial-reality device may create an acoustic transfer function that is specific to the location of the device and the detected direction of arrival of the sound signal. In some aspects, the artificial-reality device may re-render the source signal in a stereo device or multi-speaker device (e.g., a surround sound device). In such cases, separate and distinct audio signals may be sent to each speaker. Each of these audio signals may be altered according to the user's HRTF and according to measurements of the user's location and the location of the sound source to sound as if they are coming from the determined location of the sound source. Accordingly, in this manner, the artificial-reality device (or speakers associated with the device) may re-render an audio signal to sound as if originating from a specific location.

In some aspects, the systems described herein may also include an eye-tracking subsystem designed to identify and track various characteristics of a user's eye(s), such as the user's gaze direction. The phrase “eye tracking” may, in some examples, refer to a process by which the position, orientation, and/or motion of an eye is measured, detected, sensed, determined, and/or monitored. The disclosed systems may measure the position, orientation, and/or motion of an eye in a variety of different ways, including through the use of various optical-based eye-tracking techniques, ultrasound-based eye-tracking techniques, etc. An eye-tracking subsystem may be configured in a number of different ways and may include a variety of different eye-tracking hardware components or other computer-vision components. For example, an eye-tracking subsystem may include a variety of different optical sensors, such as two-dimensional (2D) or 3D cameras, time-of-flight depth sensors, single-beam or sweeping laser rangefinders, 3D LiDAR sensors, and/or any other suitable type or form of optical sensor. In this example, a processing subsystem may process data from one or more of these sensors to measure, detect, determine, and/or otherwise monitor the position, orientation, and/or motion of the user's eye(s).

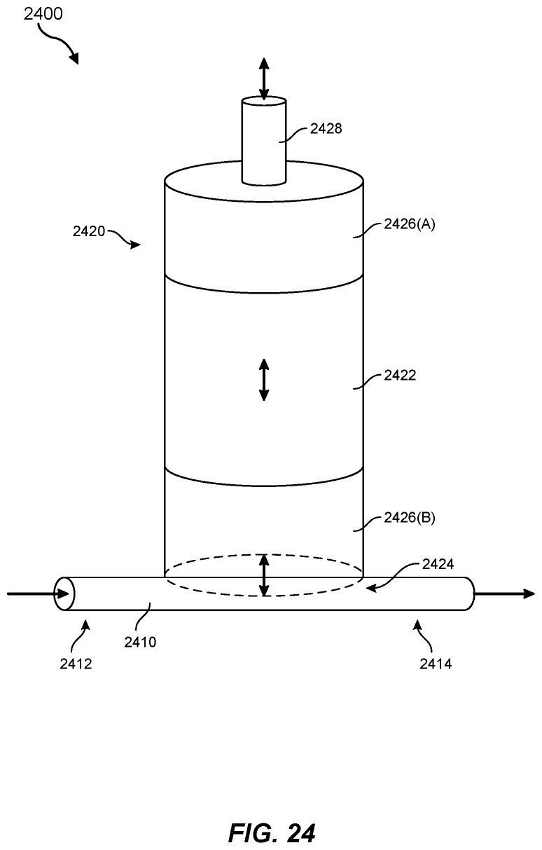

FIG. 24 is an illustration of an example system 2400 that incorporates an eye-tracking subsystem capable of tracking a user's eye(s). As depicted in FIG. 24, system 2400 may include a light source 2402, an optical subsystem 2404, an eye-tracking subsystem 2406, and/or a control subsystem 2408. In some examples, light source 2402 may generate light for an image (e.g., to be presented to an eye 2401 of the viewer). Light source 2402 may represent any of a variety of suitable devices. For example, light source 2402 can include a two-dimensional projector (e.g., a LCoS display), a scanning source (e.g., a scanning laser), or other device (e.g., an LCD, an LED display, an OLED display, an active-matrix OLED display (AMOLED), a transparent OLED display (TOLED), a waveguide, or some other display capable of generating light for presenting an image to the viewer). In some examples, the image may represent a virtual image, which may refer to an optical image formed from the apparent divergence of light rays from a point in space, as opposed to an image formed from the light ray's actual divergence.

In some aspects, optical subsystem 2404 may receive the light generated by light source 2402 and generate, based on the received light, converging light 2420 that includes the image. In some examples, optical subsystem 2404 may include any number of lenses (e.g., Fresnel lenses, convex lenses, concave lenses), apertures, filters, mirrors, prisms, and/or other optical components, possibly in combination with actuators and/or other devices. In particular, the actuators and/or other devices may translate and/or rotate one or more of the optical components to alter one or more aspects of converging light 2420. Further, various mechanical couplings may serve to maintain the relative spacing and/or the orientation of the optical components in any suitable combination.

In one aspect, eye-tracking subsystem 2406 may generate tracking information indicating a gaze angle of an eye 2401 of the viewer. In this aspect, control subsystem 2408 may control aspects of optical subsystem 2404 (e.g., the angle of incidence of converging light 2420) based at least in part on this tracking information. Additionally, in some examples, control subsystem 2408 may store and utilize historical tracking information (e.g., a history of the tracking information over a given duration, such as the previous second or fraction thereof) to anticipate the gaze angle of eye 2401 (e.g., an angle between the visual axis and the anatomical axis of eye 2401). In some aspects, eye-tracking subsystem 2406 may detect radiation emanating from some portion of eye 2401 (e.g., the cornea, the iris, the pupil, or the like) to determine the current gaze angle of eye 2401. In other examples, eye-tracking subsystem 2406 may employ a wavefront sensor to track the current location of the pupil.

Any number of techniques can be used to track eye 2401. Some techniques may involve illuminating eye 2401 with infrared light and measuring reflections with at least one optical sensor that is tuned to be sensitive to the infrared light. Information about how the infrared light is reflected from eye 2401 may be analyzed to determine the position(s), orientation(s), and/or motion(s) of one or more eye feature(s), such as the cornea, pupil, iris, and/or retinal blood vessels.

In some examples, the radiation captured by a sensor of eye-tracking subsystem 2406 may be digitized (i.e., converted to an electronic signal). Further, the sensor may transmit a digital representation of this electronic signal to one or more processors (for example, processors associated with a device including eye-tracking subsystem 2406). Eye-tracking subsystem 2406 may include any of a variety of sensors in a variety of different configurations. For example, eye-tracking subsystem 2406 may include an infrared detector that reacts to infrared radiation. The infrared detector may be a thermal detector, a photonic detector, and/or any other suitable type of detector. Thermal detectors may include detectors that react to thermal effects of the incident infrared radiation.

In some examples, one or more processors may process the digital representation generated by the sensor(s) of eye-tracking subsystem 2406 to track the movement of eye 2401. In another example, these processors may track the movements of eye 2401 by executing algorithms represented by computer-executable instructions stored on non-transitory memory. In some examples, on-chip logic (e.g., an application-specific integrated circuit or ASIC) may be used to perform at least portions of such algorithms. As noted, eye-tracking subsystem 2406 may be programmed to use an output of the sensor(s) to track movement of eye 2401. In some aspects, eye-tracking subsystem 2406 may analyze the digital representation generated by the sensors to extract eye rotation information from changes in reflections. In one aspect, eye-tracking subsystem 2406 may use corneal reflections or glints (also known as Purkinje images) and/or the center of the eye's pupil 2422 as features to track over time.

In some aspects, eye-tracking subsystem 2406 may use the center of the eye's pupil 2422 and infrared or near-infrared, non-collimated light to create corneal reflections. In these aspects, eye-tracking subsystem 2406 may use the vector between the center of the eye's pupil 2422 and the corneal reflections to compute the gaze direction of eye 2401. In some aspects, the disclosed systems may perform a calibration procedure for an individual (using, e.g., supervised or unsupervised techniques) before tracking the user's eyes. For example, the calibration procedure may include directing users to look at one or more points displayed on a display while the eye-tracking system records the values that correspond to each gaze position associated with each point.

In some aspects, eye-tracking subsystem 2406 may use two types of infrared and/or near-infrared (also known as active light) eye-tracking techniques: bright-pupil and dark-pupil eye tracking, which may be differentiated based on the location of an illumination source with respect to the optical elements used. If the illumination is coaxial with the optical path, then eye 2401 may act as a retroreflector as the light reflects off the retina, thereby creating a bright pupil effect similar to a red-eye effect in photography. If the illumination source is offset from the optical path, then the eye's pupil 2422 may appear dark because the retroreflection from the retina is directed away from the sensor. In some aspects, bright-pupil tracking may create greater iris/pupil contrast, allowing more robust eye tracking with iris pigmentation, and may feature reduced interference (e.g., interference caused by eyelashes and other obscuring features). Bright-pupil tracking may also allow tracking in lighting conditions ranging from total darkness to a very bright environment.

In some aspects, control subsystem 2408 may control light source 2402 and/or optical subsystem 2404 to reduce optical aberrations (e.g., chromatic aberrations and/or monochromatic aberrations) of the image that may be caused by or influenced by eye 2401. In some examples, as mentioned above, control subsystem 2408 may use the tracking information from eye-tracking subsystem 2406 to perform such control. For example, in controlling light source 2402, control subsystem 2408 may alter the light generated by light source 2402 (e.g., by way of image rendering) to modify (e.g., pre-distort) the image so that the aberration of the image caused by eye 2401 is reduced.

The disclosed systems may track both the position and relative size of the pupil (since, e.g., the pupil dilates and/or contracts). In some examples, the eye-tracking devices and components (e.g., sensors and/or sources) used for detecting and/or tracking the pupil may be different (or calibrated differently) for different types of eyes. For example, the frequency range of the sensors may be different (or separately calibrated) for eyes of different colors and/or different pupil types, sizes, and/or the like. As such, the various eye-tracking components (e.g., infrared sources and/or sensors) described herein may need to be calibrated for each individual user and/or eye.

The disclosed systems may track both eyes with and without ophthalmic correction, such as that provided by contact lenses worn by the user. In some aspects, ophthalmic correction elements (e.g., adjustable lenses) may be directly incorporated into the artificial reality systems described herein. In some examples, the color of the user's eye may necessitate modification of a corresponding eye-tracking algorithm. For example, eye-tracking algorithms may need to be modified based at least in part on the differing color contrast between a brown eye and, for example, a blue eye.

FIG. 25 is a more detailed illustration of various aspects of the eye-tracking subsystem illustrated in FIG. 24. As shown in this figure, an eye-tracking subsystem 2500 may include at least one source 2504 and at least one sensor 2506. Source 2504 generally represents any type or form of element capable of emitting radiation. In one example, source 2504 may generate visible, infrared, and/or near-infrared radiation. In some examples, source 2504 may radiate non-collimated infrared and/or near-infrared portions of the electromagnetic spectrum towards an eye 2502 of a user. Source 2504 may utilize a variety of sampling rates and speeds. For example, the disclosed systems may use sources with higher sampling rates in order to capture fixational eye movements of a user's eye 2502 and/or to correctly measure saccade dynamics of the user's eye 2502. As noted above, any type or form of eye-tracking technique may be used to track the user's eye 2502, including optical-based eye-tracking techniques, ultrasound-based eye-tracking techniques, etc.

Sensor 2506 generally represents any type or form of element capable of detecting radiation, such as radiation reflected off the user's eye 2502. Examples of sensor 2506 include, without limitation, a charge coupled device (CCD), a photodiode array, a complementary metal-oxide-semiconductor (CMOS) based sensor device, and/or the like. In one example, sensor 2506 may represent a sensor having predetermined parameters, including, but not limited to, a dynamic resolution range, linearity, and/or other characteristic selected and/or designed specifically for eye tracking.

As detailed above, eye-tracking subsystem 2500 may generate one or more glints. As detailed above, a glint 2503 may represent reflections of radiation (e.g., infrared radiation from an infrared source, such as source 2504) from the structure of the user's eye. In various aspects, glint 2503 and/or the user's pupil may be tracked using an eye-tracking algorithm executed by a processor (either within or external to an artificial reality device). For example, an artificial reality device may include a processor and/or a memory device in order to perform eye tracking locally and/or a transceiver to send and receive the data necessary to perform eye tracking on an external device (e.g., a mobile phone, cloud server, or other computing device).

FIG. 25 shows an example image 2505 captured by an eye-tracking subsystem, such as eye-tracking subsystem 2500. In this example, image 2505 may include both the user's pupil 2508 and a glint 2510 near the same. In some examples, pupil 2508 and/or glint 2510 may be identified using an artificial-intelligence-based algorithm, such as a computer-vision-based algorithm. In one aspect, image 2505 may represent a single frame in a series of frames that may be analyzed continuously in order to track the eye 2502 of the user. Further, pupil 2508 and/or glint 2510 may be tracked over a period of time to determine a user's gaze.

In one example, eye-tracking subsystem 2500 may be configured to identify and measure the inter-pupillary distance (IPD) of a user. In some aspects, eye-tracking subsystem 2500 may measure and/or calculate the IPD of the user while the user is wearing the artificial reality system. In these aspects, eye-tracking subsystem 2500 may detect the positions of a user's eyes and may use this information to calculate the user's IPD.

As noted, the eye-tracking systems or subsystems disclosed herein may track a user's eye position and/or eye movement in a variety of ways. In one example, one or more light sources and/or optical sensors may capture an image of the user's eyes. The eye-tracking subsystem may then use the captured information to determine the user's inter-pupillary distance, interocular distance, and/or a 3D position of each eye (e.g., for distortion adjustment purposes), including a magnitude of torsion and rotation (i.e., roll, pitch, and yaw) and/or gaze directions for each eye. In one example, infrared light may be emitted by the eye-tracking subsystem and reflected from each eye. The reflected light may be received or detected by an optical sensor and analyzed to extract eye rotation data from changes in the infrared light reflected by each eye.

The eye-tracking subsystem may use any of a variety of different methods to track the eyes of a user. For example, a light source (e.g., infrared light-emitting diodes) may emit a dot pattern onto each eye of the user. The eye-tracking subsystem may then detect (e.g., via an optical sensor coupled to the artificial reality system) and analyze a reflection of the dot pattern from each eye of the user to identify a location of each pupil of the user. Accordingly, the eye-tracking subsystem may track up to six degrees of freedom of each eye (i.e., 3D position, roll, pitch, and yaw) and at least a subset of the tracked quantities may be combined from two eyes of a user to estimate a gaze point (i.e., a 3D location or position in a virtual scene where the user is looking) and/or an IPD.

In some cases, the distance between a user's pupil and a display may change as the user's eye moves to look in different directions. The varying distance between a pupil and a display as viewing direction changes may be referred to as “pupil swim” and may contribute to distortion perceived by the user as a result of light focusing in different locations as the distance between the pupil and the display changes. Accordingly, measuring distortion at different eye positions and pupil distances relative to displays and generating distortion corrections for different positions and distances may allow mitigation of distortion caused by pupil swim by tracking the 3D position of a user's eyes and applying a distortion correction corresponding to the 3D position of each of the user's eyes at a given point in time. Thus, knowing the 3D position of each of a user's eyes may allow for the mitigation of distortion caused by changes in the distance between the pupil of the eye and the display by applying a distortion correction for each 3D eye position. Furthermore, as noted above, knowing the position of each of the user's eyes may also enable the eye-tracking subsystem to make automated adjustments for a user's IPD.

In some aspects, a display subsystem may include a variety of additional subsystems that may work in conjunction with the eye-tracking subsystems described herein. For example, a display subsystem may include a varifocal subsystem, a scene-rendering module, and/or a vergence-processing module. The varifocal subsystem may cause left and right display elements to vary the focal distance of the display device. In one aspect, the varifocal subsystem may physically change the distance between a display and the optics through which it is viewed by moving the display, the optics, or both. Additionally, moving or translating two lenses relative to each other may also be used to change the focal distance of the display. Thus, the varifocal subsystem may include actuators or motors that move displays and/or optics to change the distance between them. This varifocal subsystem may be separate from or integrated into the display subsystem. The varifocal subsystem may also be integrated into or separate from its actuation subsystem and/or the eye-tracking subsystems described herein.

In one example, the display subsystem may include a vergence-processing module configured to determine a vergence depth of a user's gaze based on a gaze point and/or an estimated intersection of the gaze lines determined by the eye-tracking subsystem. Vergence may refer to the simultaneous movement or rotation of both eyes in opposite directions to maintain single binocular vision, which may be naturally and automatically performed by the human eye. Thus, a location where a user's eyes are verged is where the user is looking and is also typically the location where the user's eyes are focused. For example, the vergence-processing module may triangulate gaze lines to estimate a distance or depth from the user associated with intersection of the gaze lines. The depth associated with intersection of the gaze lines may then be used as an approximation for the accommodation distance, which may identify a distance from the user where the user's eyes are directed. Thus, the vergence distance may allow for the determination of a location where the user's eyes should be focused and a depth from the user's eyes at which the eyes are focused, thereby providing information (such as an object or plane of focus) for rendering adjustments to the virtual scene.

The vergence-processing module may coordinate with the eye-tracking subsystems described herein to make adjustments to the display subsystem to account for a user's vergence depth. When the user is focused on something at a distance, the user's pupils may be slightly farther apart than when the user is focused on something close. The eye-tracking subsystem may obtain information about the user's vergence or focus depth and may adjust the display subsystem to be closer together when the user's eyes focus or verge on something close and to be farther apart when the user's eyes focus or verge on something at a distance.

The eye-tracking information generated by the above-described eye-tracking subsystems may also be used, for example, to modify various aspect of how different computer-generated images are presented. For example, a display subsystem may be configured to modify, based on information generated by an eye-tracking subsystem, at least one aspect of how the computer-generated images are presented. For instance, the computer-generated images may be modified based on the user's eye movement, such that if a user is looking up, the computer-generated images may be moved upward on the screen. Similarly, if the user is looking to the side or down, the computer-generated images may be moved to the side or downward on the screen. If the user's eyes are closed, the computer-generated images may be paused or removed from the display and resumed once the user's eyes are back open.

The above-described eye-tracking subsystems can be incorporated into one or more of the various artificial reality systems described herein in a variety of ways. For example, one or more of the various components of system 2400 and/or eye-tracking subsystem 2500 may be incorporated into any of the augmented-reality systems in and/or virtual-reality systems described herein in to enable these systems to perform various eye-tracking tasks (including one or more of the eye-tracking operations described herein).

As noted above, the present disclosure may also include haptic fluidic systems that involve the control (e.g., stopping, starting, restricting, increasing, etc.) of fluid flow through a fluid channel. The control of fluid flow may be accomplished with a fluidic valve. FIG. 26 shows a schematic diagram of a fluidic valve 2600 for controlling flow through a fluid channel 2610, according to at least one aspect of the present disclosure. Fluid from a fluid source (e.g., a pressurized fluid source, a fluid pump, etc.) may flow through the fluid channel 2610 from an inlet port 2612 to an outlet port 2614, which may be operably coupled to, for example, a fluid-driven mechanism, another fluid channel, or a fluid reservoir.

Fluidic valve 2600 may include a gate 2620 for controlling the fluid flow through fluid channel 2610. Gate 2620 may include a gate transmission element 2622, which may be a movable component that is configured to transmit an input force, pressure, or displacement to a restricting region 2624 to restrict or stop flow through the fluid channel 2610. Conversely, in some examples, application of a force, pressure, or displacement to gate transmission element 2622 may result in opening restricting region 2624 to allow or increase flow through the fluid channel 2610. The force, pressure, or displacement applied to gate transmission element 2622 may be referred to as a gate force, gate pressure, or gate displacement. Gate transmission element 2622 may be a flexible element (e.g., an elastomeric membrane, a diaphragm, etc.), a rigid element (e.g., a movable piston, a lever, etc.), or a combination thereof (e.g., a movable piston or a lever coupled to an elastomeric membrane or diaphragm).

As illustrated in FIG. 26, gate 2620 of fluidic valve 2600 may include one or more gate terminals, such as an input gate terminal 2626(A) and an output gate terminal 2626(B) (collectively referred to herein as “gate terminals 2626”) on opposing sides of gate transmission element 2622. Gate terminals 2626 may be elements for applying a force (e.g., pressure) to gate transmission element 2622. By way of example, gate terminals 2626 may each be or include a fluid chamber adjacent to gate transmission element 2622. Alternatively or additionally, one or more of gate terminals 2626 may include a solid component, such as a lever, screw, or piston, that is configured to apply a force to gate transmission element 2622.

In some examples, a gate port 2628 may be in fluid communication with input gate terminal 2626(A) for applying a positive or negative fluid pressure within the input gate terminal 2626(A). A control fluid source (e.g., a pressurized fluid source, a fluid pump, etc.) may be in fluid communication with gate port 2628 to selectively pressurize and/or depressurize input gate terminal 2626(A). In additional aspects, a force or pressure may be applied at the input gate terminal 2626(A) in other ways, such as with a piezoelectric element or an electromechanical actuator, etc.

In the aspect illustrated in FIG. 26, pressurization of the input gate terminal 2626(A) may cause the gate transmission element 2622 to be displaced toward restricting region 2624, resulting in a corresponding pressurization of output gate terminal 2626(B). Pressurization of output gate terminal 2626(B) may, in turn, cause restricting region 2624 to partially or fully restrict to reduce or stop fluid flow through the fluid channel 2610. Depressurization of input gate terminal 2626(A) may cause gate transmission element 2622 to be displaced away from restricting region 2624, resulting in a corresponding depressurization of the output gate terminal 2626(B). Depressurization of output gate terminal 2626(B) may, in turn, cause restricting region 2624 to partially or fully expand to allow or increase fluid flow through fluid channel 2610. Thus, gate 2620 of fluidic valve 2600 may be used to control fluid flow from inlet port 2612 to outlet port 2614 of fluid channel 2610.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary aspects disclosed herein. This exemplary description is not intended to be exhaustive or to be limited to any precise form disclosed. Many modifications and variations are possible without departing from the spirit and scope of the present disclosure. The aspects disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A method comprising:
using an array of sensors to record a pitch-catch waveform;
processing the recorded pitch-catch waveform to create a time reversed pitch-catch waveform;
emitting the time reversed pitch-catch waveform;
re-emitting the time reversed pitch-catch waveform to record a pulse-echo measurement of the time reversed pitch-catch waveform;
combining the recorded pulse-echo measurement of the time reversed pitch-catch waveform and the time reversed pitch-catch waveform; and
generating a final output of the pitch-catch waveform.

2. A method comprising:
detecting, by a system, a plurality of users concurrently listening to an audio stream in a plurality of audio sources;
muting, by the system, at least a portion of the audio stream based on detecting the plurality of users listening to the audio stream; and
transmitting the audio stream comprising the muted portion of the audio stream.
